(19) United States
(12) Patent Application Publication
(10) Pub. No.: US 2023/0274743 A1
(43) Pub. Date: Aug. 31, 2023

(54) Methods and systems enabling natural language processing, understanding, and generation

(71) Applicant: Embodied, Inc., Pasadena, CA (US)

(72) Inventors: Stefan Scherer, Santa Monica, CA (US); Mario Munich, La Canada, CA (US); Paolo Pirjanian, Glendale, CA (US); Dave Benson, Altadena, CA (US); Justin Beghtol, Santa Ana, CA (US); Rithesh Murthy, La Jolla, CA (US); Taylor Shin, Irvine, CA (US); Catherine Thornton, London (GB); Erica Gardner, Seattle, WA (US); Benjamin Gittelson, Atlanta, GA (US); Wilson Harron, Los Angeles, CA (US); Caitlyn Clabaugh, Los Angeles, CA (US)

(21) Appl. No.: 18/016,469

(22) PCT Filed: Jan. 28, 2022
(86) PCT No.: PCT/US22/14213

§ 371 Date: Jan. 17, 2023

Related U.S. Application Data
(60) Provisional application No. 63/303,860, filed on Jan. 27, 2022.
(60) Provisional application No. 63/143,000, filed on Jan. 28, 2021.

(51) Int. Cl. G10L 15/26; G06F 40/30

(52) U.S. Cl. CPC G10L 15/26; G06F 40/30

(57) ABSTRACT

Systems and methods for establishing multi-turn communications between a robot device and an individual are disclosed. Implementations may: receive one or more input text files associated with the individual's speech; filter the one or more input text files to verify the one or more input text files are not associated with prohibited subjects; analyze the one or more input text files to determine an intention on the individuals speech; perform actions based on the analyzed intention; generate one or more output text files based on the performed actions; communicate the created one or more output text files to the markup module; analyze the received one or more output text files for sentiment; based on sentiment analysis, associating an emotion indicator, and/or multimodal output actions with the one or more output text files; verify, by the prohibited speech filter, the one or more output text files do not include prohibited subjects.

### RELATED APPLICATIONS

This Patent Cooperation Treaty (PCT) application claims priority to U.S. provisional patent application Ser. No. 63/303,860, filed Jan. 27, 2022 and entitled “Methods and systems enabling natural language processing, understanding, and generation” and U.S. provisional patent application Ser. No. 63/143,000, filed Jan. 28, 2021 and entitled “SocialX Chat—Methods and systems enabling natural language processing, understanding, and generation on the edge, ” the disclosures of which are both hereby incorporated by reference in their entirety.

This application is related to SYSTEMS AND METHODS TO MANAGE CONVERSATION INTERACTIONS BETWEEN A USER AND A ROBOT COMPUTING DEVICE OR CONVERSATION AGENT, Application Ser. No. 62/983,592, filed Feb. 29, 2020, and SYSTEMS AND METHODS FOR SHORT- AND LONG-TERM DIALOG MANAGEMENT BETWEEN A ROBOT COMPUTING DEVICE/DIGITAL COMPANION AND A USER, application Ser. No. 62/983,592, filed Feb. 29, 2020, the contents of which are incorporated herein by reference in their entirety,

### FIELD OF THE DISCLOSURE

The present disclosure relates to systems and methods for establishing or generating multi-turn communications between a robot device and an individual, consumer or user, where the systems or methods utilize a SocialX cloud-based conversation module to assist in communication generation.

### BACKGROUND

Since the dawn of artificial intelligence (AI), there has been a strong desire to create autonomous agents that are capable of natural communication with human users. While conversational agents (e.g., Alexa, Google Home, or Siri) have made their way into our daily lives, their conversational capabilities are still very limited. Specifically, conversation interactions only function in a single-transactional fashion also called command-response interactions (i.e., the human user has an explicit request and the agent provides a single response). However, multiturn conversations interactions are rare if not non-existent and do not go beyond direct requests to gather information and/or reduce ambiguity. For example, a sample conversation may look like User: Alexa, I want to make a reservation; Alexa/Machine: Ok, which restaurant ?; User: Tar and Roses in Santa Monica; and Alexa makes the reservation. Modern machine learning technologies (i.e., transformer models such as GPT-2 or GPT-3) have opened up possibilities that go beyond those of current intent-based transactional conversational agents. These models are able to generate seemingly human sounding stories, conversations, news articles, (e.g., OpenAI even (in a publicity stunt) called these technologies as too dangerous to be made publicly available).

However, these modern machine learning models come with a number of significant drawbacks: First, these models are massive and cannot run on lean IoT devices (e.g., such as robot computing devices) that have limited computational power and memory. Second, even when run on a GPU-accelerated machine, these models take several seconds to generate an output which is prohibitive for real-time conversational agents. As a general rule, the sense-act loop for such conversational agents needs to be below 400-500 ms to maintain engagement with the human or consumer. Third, these massive machine learning models are trained on enormous amounts of data (basically the entirety of the internet) and are therefore tainted by the following drawbacks: (1) lewd language; (2) false and unverified information (e.g., the model might claim that Michael Crichton was the director of the movie Jurassic Park, while he was only the author of the book); (3) represent a generic point of view rather than a specific point of view (e.g., in one instance this model could be democrat and in the next republican, in one instance the favorite food could be steak and in the next the model could be a strict vegan, etc.); (4) training takes an enormous amount of time and energy and therefore a model represents a single moment in time (e.g., the vast majority of state of the art models have been trained on data collected in 2019 and have therefore never heard of Covid-19); and (5) again due to the fact that this data originates from everyone writing on the internet, the used language is generic and does not represent the voice of a single persona (e.g., in one instance the model might generate sentences that are believably expressed by a child such as “Toy Story is my favorite movie” and in the next it could generate “I have three children and work as an accountant”). Fourth, the models taken by themselves still only have short-term memory that washes out over a few conversational turns and are not capable of building a long-term relationship with a human user or consumer.

### SUMMARY

One aspect of the present disclosure relates to a system configured for establishing or generating multi-turn communications between a robot device and an individual. The system may include one or more hardware processors configured by machine-readable instructions. The processor(s) may be configured to receive, from a computing device performing speech-to-text recognition, one or more input text files associated with the individual's speech. The processor(s) may be configured to filter, via a prohibited speech filter, the one or more input text files to verify the one or more input text files are not associated with prohibited subjects. The processor(s) may be configured to analyze the one or more input text files to determine an intention on the individual's speech. The processor(s) may be configured to perform actions on the one or more input text files based at least in part on the analyzed intention. The processor(s) may be configured to generate one or more output text files based on the performed actions. The processor(s) may be configured to communicate the created one or more output text files to the markup module. The processor(s) may be configured to analyze, by the markup module, the received one or more output text files for sentiment. The processor(s) may be configured to, based at least in part on the sentiment analysis, associating an emotion indicator, and/or multimodal output actions for the robot device with the one or more output text files. The processor(s) may be configured to verify, by the prohibited speech filter, that one or more output text files do not include prohibited subjects. The processor(s) may be configured to analyze the one or more output text files, the associated emotion indicator and/or the multimodal output actions to verify conformance with robot device persona parameters. These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1A is a diagram depicting system architecture of a robot computing device according to some embodiments;

FIG. 1B illustrates a system for a social robot or digital companion to engage a child and/or a parent, in accordance with one or more implementations;

FIG. 1C illustrates a system for a social robot or digital companion to engage a child and/or a parent, in accordance with one or more implementations;

FIG. 2 illustrates a system architecture of an exemplary robot computing device, according to some implementations;

FIG. 3A illustrates a system architecture of a SocialX Cloud-based conversation System according to some embodiments;

FIG. 3B illustrates a dataflow for processing a chat request in the SocialX Cloud-based System according to some embodiments;

FIG. 3C illustrates a dataflow for processing a question related to the robot's backstory according to some embodiments;

FIG. 3D illustrates a dataflow for processing an intent classification request according to some embodiments;

FIG. 3E illustrates a dataflow for answering a question by a third-party application according to some embodiments;

FIG. 3F illustrates a dataflow for processing a conversation summary request according to some embodiments;

FIG. 3G illustrates a dataflow for processing and dealing with a persona violation incident according to some embodiments;

FIG. 3H illustrates a dataflow for processing an output violation incidence or occurrence according to some embodiments;

FIG. 3I illustrates a dataflow for an input speech or text violation incidence or occurrence according to some embodiments;

FIG. 3J illustrates a dataflow for processing a request for past information about the robot and/or consumer communication cording to some embodiments;

FIG. 3K illustrates a system 300 configured for establishing or generating multi-turn communications between a robot device and an individual, in accordance with one or more implementations;

FIG. 3L illustrates utilization of multimodal intent recognition in the conversation module according to some embodiments;

FIG. 3M illustrates utilization of environmental cues, parameters, measurements or files for intent recognition according to some embodiments;

FIG. 3N illustrates a third party computing device that a user is engaged with providing answer to questions according to some embodiments;

FIG. 4A illustrates a method 400 for utilizing a cloud-based conversation module to establish multi-turn communications between a robot device and an individual, in accordance with one or more implementations;

FIG. 4B further illustrates a method for utilizing a cloud-based conversation module to establish multi-turn communications between a robot device and an individual, in accordance with one or more implementations;

FIG. 4C illustrates retrieving factual information requested and providing the factual information according to some embodiments;

FIG. 4D illustrates a method of a SocialX cloud-based conversation module identifying special topics and redirecting conversation away from the special topic according to some embodiments;

FIG. 4E illustrates a cloud-based conversation module to utilize delay techniques in responding to users and/or consumers according to some embodiments;

FIG. 4F illustrates a cloud-based conversation module to extract and/or store contextual information from one or more input text files according to some embodiments; and

FIG. 4G illustrates analyzing for one or more input text files for relevant conversational and/or metaphorical aspects according to some embodiments;

### DETAILED DESCRIPTION

The subject matter in this document represents a composition of novel algorithms and systems enabling safe persons-based multimodal natural conversational agents with long-term memory and access to correct, current, and factual information. This is because in order for conversational agents to work, the conversation model and/or module needs to keep track of context and past conversations. A conversation module or agent needs to keep track of multi-user context in which the system remembers the conversations with each member of the group and remembers the composition and roles of the members of the group. A conversation module of agent also needs to generate multimodal communication which is not only composed by language outputs but also appropriate facial expressions, gestures, and voice inflections. In addition, depending on the human user and/or their choices, the conversation agent should also be able to impersonate various personas with various limitations or access to certain modules (e.g., child content vs. adult content). These personas may be maintained by the conversation agent or module leveraging a knowledge base or database of existing information regarding the persona. The subject matter described herein allows interactive conversation agent, module or machines to naturally and efficiently communicate in a broad range of social situations. The invention differs from the current state of the art conversational agent, module or machine systems in the following way: First, the present conversation agent, module or machine leverages multimodal input comprising microphone array, camera, radar, lidar, and infrared camera, to track the environment and maintain a persistent view of the world around it. See MULTIMODAL BEAMFORMING AND ATTENTION FILTERING FOR MULTIPARTY INTERACTIONS, Application Ser. No. 62/983,595, filed Feb. 29, 2020. Second, the present conversation agent, module or machine system tracks the engagement of the users around it leveraging the methods and systems described in the SYSTEMS AND METHODS TO MANAGE CONVERSATION INTERACTIONS BETWEEN A USER AND A ROBOT COMPUTING DEVICE OR CONVERSATION AGENT patent application Ser. No. 62/983,590, filed Feb. 29, 2020. Third, once a user is engaged, the conversation agent, module or machine analyzes the user's behavior and assesses linguistic context, facial expression, posture, gestures, voice inflection, etc., to better understand the intent and meaning of the user's comments, questions, and/or affect. Fourth, the conversation agent, module or machine analyzes the user's multimodal natural behavior to identify when it is the conversation agent's, module's or machine's turn to take the floor (e.g., to respond to the consumer or user or to initiate a conversation turn with the user).

Fifth, the conversation agent, module or machine responds to the user by utilizing and/or leveraging multimodal output and signals when it is time for the conversation agent, module or machine to respond. See SYSTEMS AND METHODS TO MANAGE CONVERSATION INTERACTIONS BETWEEN A USER AND A ROBOT COMPUTING DEVICE OR CONVERSATION AGENT, Application Ser. No. 62/983,592, filed Feb. 29, 2020, and SYSTEMS AND METHODS FOR SHORT- AND LONG-TERM DIALOG MANAGEMENT BETWEEN A ROBOT COMPUTING DEVICE/DIGITAL COMPANION AND A USER, application serial No. 62/983,592, filed Feb. 29, 2020. Sixth, the conversation agent, module or machine system identifies when to engage the cloud-based NLP modules based on, special commands (e.g., Moxie, let's chat), planned scheduling, special markup (e.g., open question). and/or a lack of or mismatched authored patterns on the robot (i.e., fallback handling); and or depending on the complexity of the ideas or context of the one or more text files received from the speech-to-text converting module, Seventh, the conversation agent, module or machine system may engage in masking techniques (or utilize multimodal outputs to display thinking behavior) to hide the fact that there is likely to be a time delay between request in the received one or more input text files and receipt of response from the SocialX cloud-based module (e.g., by speaking hmm, let me think about that, and also utilizing facial expressions to simulate a thinking behavior). The conversation agent, module or machine system utilizes this behavior and these actions because they are essential to maintain user engagement and tighten the sense-act loop of the agent.

Eighth, in some embodiments, all input and output from the conversation agent, module of machine system may get filtered by an ensemble of intent recognizer model modules to identify taboo topics, taboo language, persona violating phrases, and other out of scope responses. Ninth, once a taboo topic, etc. is identified the conversation agent, module or machine system, the conversation agent, module or machine may signal a redirect request and may initiate and/or invoke a redirect algorithm to immediately change (or quickly change) the topic of the conversation into a safe space. Tenth, in some embodiments, the conversation agent, module or machine may include an additional input filter that identifies special topics (e.g., social justice, self-harm, mental health, etc.) that trigger manually authored and specialized responses (that are stored in one or more memory modules and/or e knowledge database) that are carefully vetted interaction sequences to protect the user and the image of the automated agent. Eleventh, in some embodiments, the conversation agent, module and/or machine may include an output filter. In some embodiments, the output filter may identify a persona violation (e.g., Embodied's Moxie robot claims that it has children or was at a rock concert when it was younger) or taboo topic violation (e.g., violence, drugs, etc.), then the conversation agent, module and/or machine is informed of this violation and an algorithm of the conversation agent, module and/or machine may immediately or quickly search for one or more next best solutions (e.g., other groups of one or more text files). In some embodiments, the search may be a beam-search or k-top search or similar and may retrieve and/or find an acceptable group of one or more text files that are utilized to respond to and/or replace the persona violating output files. The replacement of one or more output text files does not contain a persona violation (or any other violation). If no such response (e.g., acceptable one or more output text files) is found after the search within a brief period of time (i.e., the robot needs to respond in close to real time—e.g., within a two to five seconds), a redirect phrase and topic reset (pre-authored) (in the form of output text files) may be selected and may be provided as a response and/or replacement for the persona violating prior output text files. These redirect phrases may be related to a certain topic to maintain consistency with the current topic (e.g., talking about space travel “What do you think the earth would look like from space?”, “Do you think humans will ever live on Mars?”, etc.), introduce a new topic (e.g., “Would you like to talk about something else? I really wanted to learn more about animals. What is the largest animal?”), or be derived from the memory module or knowledge base or database directly (e.g., “Last week we talked about ice cream. Did you have any since we talked?”). Twelfth, if s vocabulary violation (e.g., the conversation agent, module or machine produces or generates a word that is outside the vocabulary of the user population) is detected, the conversation agent, module or machine may selects a synonymous word or expression that is within the vocabulary (e.g., instead of using the biologically correct term of Alluropoda melonoleuca the agent would select Panda bear) leveraging word similarity algorithms, third party thesaurus or similar, and replace the word that created the vocabulary violation with the selected word in the output or input text files. Thirteenth, a context module may continuously monitor one of more input text files, may collect and follow the conversation to keep track of exchanged facts (e.g., the user states their name or intention to take a vacation next week, etc.) and may store these facts (in the form of text files) in one or more memory modules. In some embodiments, the conversation agent module, or machine may identify opportune moments to retrieve a memory fact from the one or more memory modules and may utilize these facts to inserts either a probing question in the form of a text file (e.g., how was your vacation last week?) or may leverage a fact (Hi, John, good to see you) to generate a text file response. In some embodiments, the conversation agent, module or machine may create abstractions of the current conversation to reduce the amount of context to be processed and stored in the one or more memory modules. In some embodiments, the conversation agent, module or machine may analyze the input one or more text flies and may, for example, eliminate redundant information as well as too detailed information (e.g., the input one or more text files representing “We went to Santa Monica from downtown on the 10 to go to the beach” may be reduced to the one or more input text files representing “We went to the beach.”)

Fourteenth, the conversation agent, module or machine may include an input filter that identifies factual questions or information retrieval questions that seek to request a certain datum (e.g., who was the fourteenth president of the United States). In some embodiments, once such a factual question has been identified, the input filter may communicate with a question and answer module to retrieve the information from a third party computing device (including but not limited to Encyclopedia Britannica or Wikipedia), through a third-party application programming interface. In another embodiment, a question or answer module may identify an appropriate context that matches the requested information (e.g., a story from the GRL that Moxie told a child earlier) and uses a question-answering algorithm (in a question/answer module) to pull or retrieve the information directly from the provided context that is stored in the memory module and/or the knowledge database. In some embodiments, the chat module may then utilize this information to generate output text files in response and the output text files including the retrieved answers is communicated to the human user after the markup module has also associated emotion indicators or parameters and/or multimodal output actions to the one or more output text files, before going through the multimodal behavior generation of the agent. Fifteenth, the markup module may receive the one or more output text files and a sentiment filer may identify the mood and/or sentiment of the output text files, relevant conversational and/or metaphorical aspects of the output text files, and/or contextual information or aspects of the one of more output text files (e.g., a character from the G.R.L., is named, or another named entity such as a Panda bear). In some embodiments, the markup module of the conversation agent, module or machine may create multimodal output actions (e.g., a behavioral markup that controls the facial expression, gestures (pointing etc.), voice (tonal inflections), as well as heads-up display (e.g., an image of a Panda bear)) to produce these actions on the robot computing device.

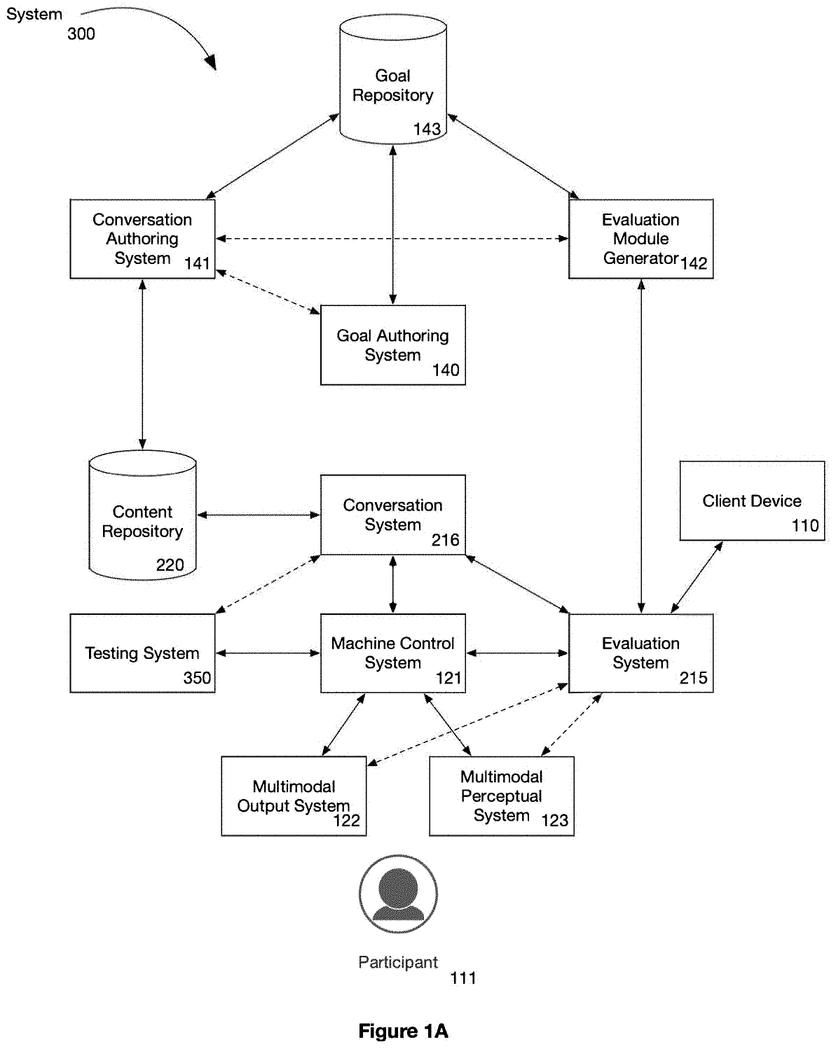

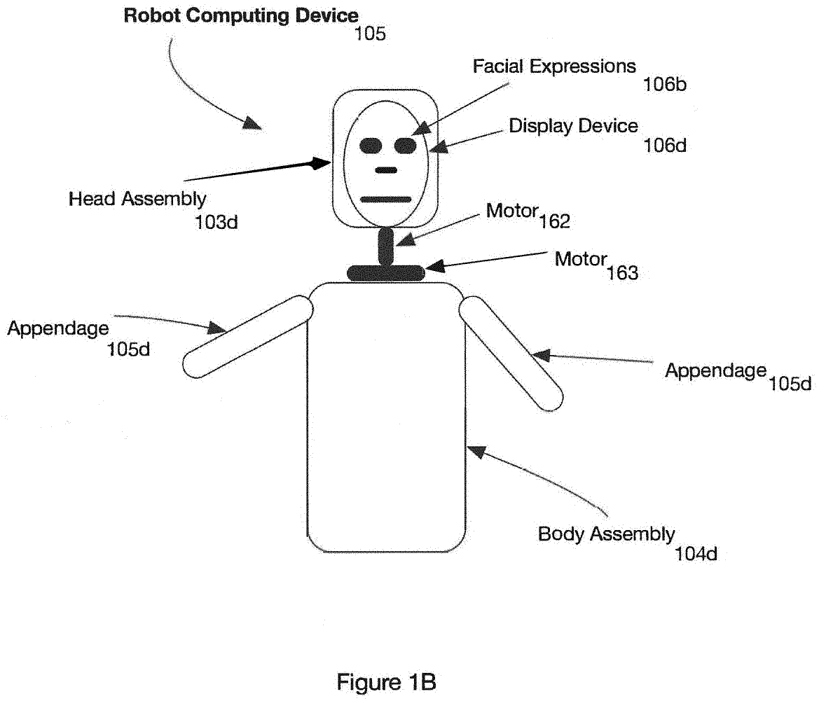

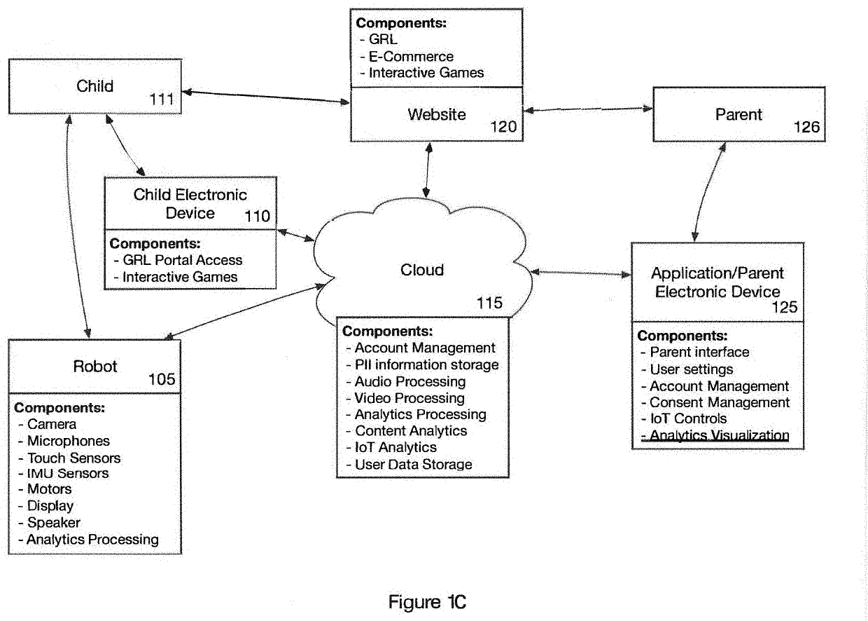

FIGS. 1B and 1C illustrates a system for a social robot, digital companion or robot computing device to engage a child and/or a parent. In some implementations, a robot computing device 105 (or digital companion) may engage with a child and establish communication interactions with the child. In some implementations, there will be bidirectional communication between the robot computing device 105 and the child 111 with a goal of establishing multi-turn conversations (e.g., both parties taking conversation turns) in the communication interactions. In some implementations, the robot computing device 105 may communicate with the child via spoken words (e.g., audio actions,), visual actions (movement of eyes or facial expressions on a display screen), and/or physical actions (e.g., movement of a neck or head or an appendage of a robot computing device). In some implementations, the robot computing device 105 may utilize imaging devices to evaluate a child's body language, a child's facial expressions and may utilize speech recognition software to evaluate and analyze the child's speech.

In some implementations, the child may also have one or more electronic devices 110. In some implementations, the one or more electronic devices 110 may allow a child to login to a website on a server computing device in order to access a learning laboratory and/or to engage in interactive games that are housed on the web site. In some implementations, the child's one or more computing devices 110 may communicate with cloud computing devices 115 in order to access the website 120. In some implementations, the website 120 may be housed on server computing devices. In some implementations, the website 120 may include the learning laboratory (which may be referred to as a global robotics laboratory (GRL) where a child can interact with digital characters or personas that are associated with the robot computing device 105. In some implementations, the website 120 may include interactive games where the child can engage in competitions or goal setting exercises. In some implementations, other users may be able to interface with an e-commerce website or program, where the other users (e.g., parents or guardians) may purchases items that are associated with the robot (e.g., comic books, toys, badges or other affiliate items).

In some implementations, the robot computing device or digital companion 105 may include one or more imaging devices, one or more microphones, one or more touch sensors, one or more IMU sensors, one or more motors and/or motor controllers, one or more display devices or monitors and/or one or more speakers. In some implementations, the robot computing devices may include one or more processors, one or more memory devices, and/or one or more wireless communication transceivers. In some implementations, computer-readable instructions may be stored in the one or more memory devices and may be executable to perform numerous actions, features and/or functions. In some implementations, the robot computing device may perform analytics processing on date, parameters and/or measurements, audio files and/or image files captured and/or obtained from the components of the robot computing device listed above.

In some implementations, the one or more touch sensors may measure if a user (child, parent or guardian) touches the robot computing device or if another object or individual comes into contact with the robot computing device. In some implementations, the one or more touch sensors may measure a force of the touch and/or dimensions of the touch to determine, for example, if it is an exploratory touch, a push away, a hug or another type of action. In some implementations, for example, the touch sensors may be located or positioned on a front and back of an appendage or a hand of the robot computing device or on a stomach area of the robot computing device. Thus, the software and/or the touch sensors may determine if s child is shaking a hand or grabbing a hand of the robot computing device or if they are rubbing the stomach of the robot computing device. In some implementations, other touch sensors may determine if the child is hugging the robot computing device. In some implementations, the touch sensors may be utilized in conjunction with other robot computing device software where the robot computing device could tell a child to hold their left hand if they want to follow one path of a story of hold a left hand if they want to follow the other path of a story.

In some implementations, the one or more imaging devices may capture images and/or video of a child, parent or guardian interacting with the robot computing device. In some implementations, the one or more imaging devices may capture images and/or video of the area around the child, parent or guardian. In some implementations, the one or more microphones may capture sound or verbal commands spoken by the child, parent or guardian. In some implementations, computer-readable instructions executable by the processor or an audio processing device may convert the captured sounds or utterances into audio files for processing. In some implementations, the one or more IMU sensors may measure velocity, acceleration, orientation and/or location of different parts of the robot computing device. In some implementations, for example, the IMU sensors may determine a speed of movement of an appendage or a neck. In some implementations, for example, the IMU sensors may determine an orientation of a section of the robot computing device, for example of a neck, a head, a body or an appendage in order to identify if the hand is waving or in a rest position. In some implementations, the use of the IMU sensors may allow the robot computing device to orient its different sections in order to appear more friendly or engaging to the user.

In some implementations, the robot computing device may have one or more motors and/or motor controllers. In some implementations, the computer-readable instructions may be executable by the one or more processors and commands or instructions may be communicated to the one or more motor controllers to send signals or commands to the motors to cause the motors to move sections of the robot computing device. In some implementations, the sections may include appendages or arms of the robot computing device and/or a neck or a head of the robot computing device.

In some implementations, the robot computing device may include a display or monitor. In some implementations, the monitor may allow the robot computing device to display facial expressions (e.g., eyes, nose, mouth expressions) as well as to display video or messages to the child, parent or guardian.

In some implementations, the robot computing device may include one or more speakers, which may be referred to as an output modality. In some implementations, the one or more speakers may enable or allow the robot computing device to communicate words, phrases and/or sentences and thus engage in conversations with the user. In addition, the one or more speakers may emit audio sounds of music for the child, parent or guardian when they are performing actions and/or engaging with the robot computing device.

In some implementations, the system may include a parent computing device 125. In some implementations, the parent computing device 125 may include one or more processors and/or one or more memory devices. In some implementations, computer-readable instructions may be executable by the one or more processors to cause the parent computing device 125 to perform a number of features and/or functions. In some implementations, these features and functions may include generating and running a parent interface for the system. In some implementations, the software executable by the parent computing device 125 may also after user (e.g., child, parent or guardian) settings. In some implementations, the software executable by the parent computing device 125 may also allow the parent or guardian to manage their own account or their child's account in the system. In some implementations, the software executable by the parent computing device 125 may allow the parent or guardian to initiate or complete parental consent to allow certain features of the robot computing device to be utilized. In some implementations, the software executable by the parent computing device 125 may allow a parent or guardian to set goals or thresholds or settings what is captured from the robot computing device and what is analyzed and/or utilized by the system. In some implementations, the software executable by the one or more processors of the parent computing device 125 may allow the parent or guardian to view the different analytics generated by the system in order to see how the robot computing device is operating, how their child is progressing against established goals, and/or how the child is interacting with the robot computing device.

In some implementations, the system may include a cloud server computing device 115. In some implementations, the cloud server computing device 115 may include one or more processors and one or more memory devices. In some implementations, computer-readable instructions may be retrieved from the one or more memory devices and executable by the one or more processors to cause the cloud server computing device 115 to perform calculations and/or additional functions. In some implementations, the software (e.g., the computer-readable instructions executable by the one or more processors) may manage accounts for all the users (e.g., the child, the parent and/or the guardian). In some implementations, the software may also manage the storage of personally identifiable information in the one or more memory devices of the cloud server computing device 115. In some implementations, the software may also execute the audio processing (e.g., speech recognition and/or context recognition) of sound files that are captured from the child, parent or guardian, as well as generating speech and related audio file that may be spoken by the robot computing device 115. In some implementations, the software in the cloud server computing device 115 may perform and/or manage the video processing of images that are received from the robot computing devices.

In some implementations, the software of the cloud server computing device 115 may analyze received inputs from the various sensors and/or other input modalities as well as gather information from other software applications as to the child's progress towards achieving set goals. In some implementations, the cloud server computing device software may be executable by the one or more processors in order perform analytics processing. In some implementations, analytics processing may be behavior analysis on how well the child is doing with respect to established goals.

In some implementations, the software of the cloud server computing device may receive input regarding how the user or child is responding to content, for example, does the child like the story, the augmented content, and/or the output being generated by the one or more output modalities of the robot computing device. In some implementations, the cloud server computing device may receive the input regarding the child's response to the content and may perform analytics on how well the content is working and whether or not certain portions of the content may not be working (e.g., perceived as boring or potentially malfunctioning or not working).

In some implementations, the software of the cloud server computing device may receive inputs such as parameters or measurements from hardware components of the robot computing device such as the sensors, the batteries, the motors, the display and/or other components. In some implementations, the software of the cloud server computing device may receive the parameters and/or measurements from the hardware components and may perform IOT Analytics processing on the received parameters, measurements or data to determine if the robot computing device is malfunctioning and/or not operating at an optimal manner.

In some implementations, the cloud server computing device 115 may include one or more memory devices. In some implementations, portions of the one or more memory devices may store user date for the various account holders. In some implementations, the user data may be user address, user goals, user details and/or preferences. In some implementations, the user data may be encrypted and/or the storage may be a secure storage.

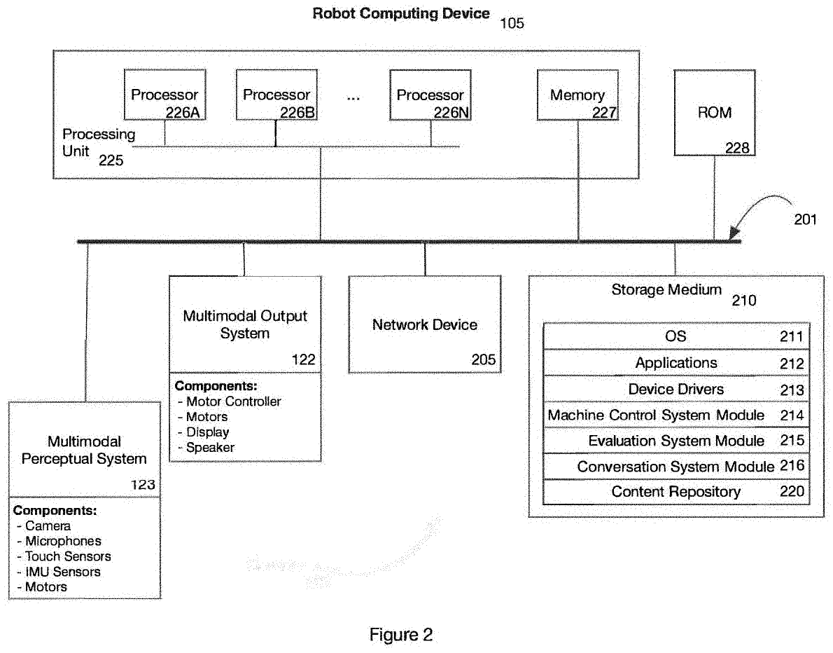

FIG. 18 illustrates a robot computing device according to some implementations. In some implementations, the robot computing device 105 may be a machine, a digital companion, an electro-mechanical device including computing devices. These terms may be utilized interchangeably in the specification. In some implementations, as shown in FIG. 18, the robot computing device 105 may include a head assembly 103d, a display device 106d, at least one mechanical appendage 105d (two are shown in FIG. 1b, a body assembly 104d, a vertical axis rotation motor 163, and a horizontal axis rotation motor 162. In some implementations, the robot 120 includes the multi-modal output system 122, the multi-modal perceptual system 123 and the machine control system 121 (not shown in FIG. 18, but shown in FIG. 2 below). In some implementations, the display device 106d may allow facial expressions 1066 to be shown of illustrated. In some implementations, the facial expressions 106b may be shown by the two or more digital eyes, digital nose and/or a digital mouth. In some implementations, the vertical axis rotation motor 163 may allow the head assembly 103d to move from side-to-side which allows the head assembly 103d to mimic human neck movement like shaking a human's head from side-to-side. In some implementations, the horizontal axis rotation motor 162 may allow the head assembly 103d to move in an up-and-down direction like shaking a human's head up and down. In some implementations, the body assembly 104d may include one or more touch sensors. In some implementations, the body assembly's touch sensor(s) may allow the robot computing device to determine if is being touched or hugged. In some implementations, the one or more appendages 105d may have one or more touch sensors. In some implementations, some of the one or more touch sensors may be located at an end of the appendages 105d (which may represent the hands). In some implementations, this allows the robot computing device 105 to determine if a user or child is touching the end of the appendage (which may represent the user shaking the user's hand).

FIG. 1A is a diagram depicting system architecture of a robot computing device. FIG. 2 is a diagram depicting system architecture of robot computing device (e.g., 105 of FIG. 1B), according to implementations. In some implementations, the robot computing device or system of FIG. 2 may be implemented as a single hardware device. In some implementations, the robot computing device and system of FIG. 2 may be implemented as a plurality of hardware devices. In some implementations, the robot computing device and system of FIG. 2 may be implemented as an ASIC (Application-Specific integrated Circuit). In some implementations, the robot computing device and system of FIG. 2 may be implemented as an FPGA (Field-Programmable Gate Array). In some implementations, the robot computing device and system of FIG. 2 may be implemented as a SoC (System-on-Chip). In some implementations, the bus 201 may interface with the processors 226A-N, the main memory 227 (e.g., a random access memory (RAM)), a read only memory (ROM) 228, one or more processor-readable storage mediums 210, and one or more network device 211. In some implementations, bus 201 interfaces with at least one of a display device (e.g., 102c) and a user input device. In some implementations, bus 101 interfaces with the multi modal output system 122. In some implementations, the multi modal output system 122 may include an audio output controller. In some implementations, the multi-modal output system 122 may include a speaker. In some implementations, the multi-modal output system 122 may include a display system or monitor. In some implementations, the multi-modal output system 122 may include a motor controller. In some implementations, the motor controller may be constructed to control the one or more appendages (e.g., 105d) of the robot system of FIG. 18. In some implementations, the motor controller may be constructed to control a motor of an appendage (e.g., 105d) of the robot system of FIG. 1B. In some implementations, the motor controller may be constructed to control a motor (e.g., a motor of a motorized, a mechanical robot appendage).

In some implementations, a bus 201 may interface with the multi modal perceptual system 123 (which may be referred to as a multi-modal input system or multi-modal input modalities. In some implementations, the multi-modal perceptual system 123 may include one or more audio input processors. In some implementations, the multi-modal perceptual system 123 may include a human reaction detection sub-system. In some implementations, the multimodal perceptual system 123 may include one or more microphones. In some implementations, the multimodal perceptual system 123 may include one or more camera(s) or imaging devices.

In some implementations, the one or more processors 226A-226N may include one or more of an ARM processor, an X86 processor, a GPU (Graphics Processing Unit), and the like. In some implementations, at least one of the processors may include at least one arithmetic logic unit (ALU) that supports a SIMD (Single Instruction Multiple Data) system that provides native support for multiply and accumulate operations.

In some implementations, at least one of a central processing unit (processor), a GPU, and a multi-processor unit (MPU) may be included. In some implementations, the processors and the main memory form a processing unit 225. In some implementations, the processing unit 225 includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some implementations, the processing unit is an ASIC (Application-Specific Integrated Circuit).

In some implementations, the processing unit may be a SoC (System-on-Chip). In some implementations, the processing unit may include at least one arithmetic logic unit (ALU) that supports a SIMD (Single Instruction Multiple Data) system that provides native support for multiply and accumulate operations. In some implementations the processing unit is a Central Processing Unit such as an Intel Xeon processor. In other implementations, the processing unit includes a Graphical Processing Unit such as NVIDIA Tesla.

In some implementations, the one or more network adapter devices or network interface devices 205 may provide one or more wired or wireless interfaces for exchanging data and commands. Such wired and wireless interfaces include, for example, a universal serial bus (USB) interface, Bluetooth interface, Wi-Fi interface, Ethernet interface, near field communication (NFC) interface, and the like. In some implementations, the one or more network adapter devices or network interface devices 205 may be wireless communication devices. In some implementations, the one or more network adapter devices or network interface devices 205 may include personal area network (PAN) transceivers, wide area network communication transceivers and/or cellular communication transceivers.

In some implementations, the one or more network devices 205 may be communicatively coupled to another robot computing device (e.g., a robot computing device similar to the robot computing device 105 of FIG. 1B). In some implementations, the one or more network devices 205 may be communicatively coupled to an evaluation system module (e.g., 215). In some implementations, the one or more network devices 205 may be communicatively coupled to a conversation system module (e.g., 110). In some implementations, the one or more network devices 205 may be communicatively coupled to a testing system 350. In some implementations, the one or more network devices 205 may be communicatively coupled to a content repository (e.g., 220). In some implementations, the one or more network devices 205 may be communicatively coupled to a client computing device (e.g., 110). In some implementations, the one or more network devices 205 may be communicatively coupled to a conversation authoring system 141 (e.g., 160). In some implementations, the one or more network devices 205 may be communicatively coupled to an evaluation module generator 142. In some implementations, the one or more network devices may be communicatively coupled to a goal authoring system. In some implementations, the one or more network devices 205 may be communicatively coupled to a goal repository 143. In some implementations, machine-executable instructions in software programs (such as an operating system 211, application programs 212, and device drivers 213) may be loaded into the one or more memory devices (of the processing unit) from the processor-readable storage medium, the ROM or any other storage location. During execution of these software programs, the respective machine-executable instructions may be accessed by at least one of processors 226A-226N (of the processing unit) via the bus 201, and then may be executed by at least one of processors. Data used by the software programs may also be stored in the one or more memory devices, and such data is accessed by at least one of one or more processors 226A-226N during execution of the machine-executable instructions of the software programs.

In some implementations, the processor-readable storage medium 210 may be one of (or & combination of two or more of) a hard drive, a flash drive, a DVD, a CD, an optical disk, a floppy disk, a flash storage, a solid state drive, a ROM, an EEPROM, an electronic circuit, a semiconductor memory device, and the like. In some implementations, the processor-readable storage medium 210 may include machine-executable instructions (and related data) for an operating system 211, software programs or application software 212, device drivers 213, and machine-executable instructions for one or more of the processors 226A-226N of FIG. 2.)

In some implementations, the processor-readable storage medium 210 may include a machine control system module 214 that includes machine-executable instructions for controlling the robot computing device to perform processes performed by the machine control system, such as moving the head assembly of robot computing device.

In some implementations, the processor-readable storage medium 210 may include an evaluation system module 215 that includes machine-executable instructions for controlling the robotic computing device to perform processes performed by the evaluation system 215. In some implementations, the processor-readable storage medium 210 may include a conversation system module 216 that may include machine-executable instructions for controlling the robot computing device 105 to perform processes performed by the conversation system 216. In some implementations, the processor-readable storage medium 210 may include machine-executable instructions for controlling the robot computing device 105 to perform processes performed by the testing system 350. In some implementations, the processor-readable storage medium 210, machine executable instructions for controlling the robot computing device 105 to perform processes performed by the conversation authoring system 141.

In some implementations, the processor-readable storage medium 210, machine-executable instructions for controlling the robot computing device 105 to perform processes performed by the goal authoring system 140. In some implementations, the processor-readable storage medium 210 may include machine-executable instructions for controlling the robot computing device 105 to perform processes performed by the evaluation module generator 142.

In some implementations, the processor-readable storage medium 210 may include the content repository 220. In some implementations, the processor-readable storage medium 210 may include the goal repository 180. In some implementations, the processor-readable storage medium 210 may include machine-executable instructions for an emotion detection module. In some implementations, emotion detection module may be constructed to detect an emotion based on captured image data (e.g., image data captured by the perceptual system 123 and/or one of the imaging devices). In some implementations, the emotion detection module may be constructed to detect an emotion based on captured audio data (e.g., audio data captured by the perceptual system 123 and/or one of the microphones). In some implementations, the emotion detection module may be constructed to detect an emotion based on captured image date and captured audio data. In some implementations, emotions detectable by the emotion detection module include anger, contempt, disgust, fear, happiness, neutral, sadness, and surprise. In some implementations, emotions detectable by the emotion detection module include happy, sad, angry, confused, disgusted, surprised, calm, unknown. In some implementations, the emotion detection module is constructed to classify detected emotions as either positive, negative, or neutral. In some implementations, the robot computing device 105 may utilize the emotion detection module to obtain, calculate or generate a determined emotion classification (e.g., positive, neutral, negative) after performance of an action by the machine, and store the determined emotion classification in association with the performed action (e.g., in the storage medium 210).

In some implementations, the testing system 350 may a hardware device or computing device separate from the robot computing device, and the testing system 350 includes at least one processor, a memory, a ROM, a network device, and a storage medium (constructed in accordance with a system architecture similar to a system architecture described herein for the machine 120), wherein the storage medium stores machine-executable instructions for controlling the testing system 350 to perform processes performed by the testing system 350, as described herein.

In some implementations, the conversation authoring system 141 may be a hardware device separate from the robot computing device 105, and the conversation authoring system 141 may include at least one processor, a memory, a ROM, a network device, and a storage medium (constructed in accordance with a system architecture similar to a system architecture described herein for the robot computing device 105), wherein the storage medium stores machine-executable instructions for controlling the conversation authoring system 141 to perform processes performed by the conversation authoring system.

In some implementations, the evaluation module generator 142 may be a hardware device separate from the robot computing device 105, and the evaluation module generator 142 may include at least one processor, a memory, a ROM, a network device, and a storage medium (constructed in accordance with a system architecture similar to a system architecture described herein for the robot computing device), wherein the storage medium stores machine-executable instructions for controlling the evaluation module generator 142 to perform processes performed by the evaluation module generator, as described herein.

In some implementations, the goal authoring system 140 may be a hardware device separate from the robot computing device, and the goal authoring system 140 may include at least one processor, a memory, a ROM, a network device, and a storage medium (constructed in accordance with a system architecture similar to a system architecture described instructions for controlling the goal authoring system to perform processes performed by the goal authoring system 140. In some implementations, the storage medium of the goal authoring system may include data, settings and/or parameters of the goal definition user interface described herein. In some implementations, the storage medium of the goal authoring system 140 may include machine-executable instructions of the goal definition user interface described herein (e.g., the user interface). In some implementations, the storage medium of the goal authoring system may include data of the goal definition information described herein (e.g., the goal definition information). In some implementations, the storage medium of the goal authoring system may include machine-executable instructions to control the goal authoring system to generate the goal definition information described herein (e.g., the goal definition information).

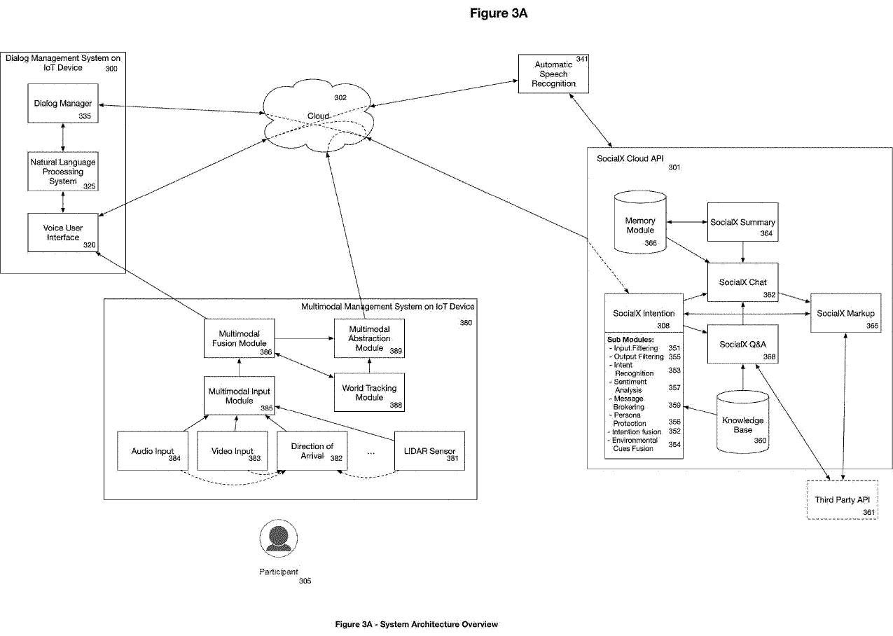

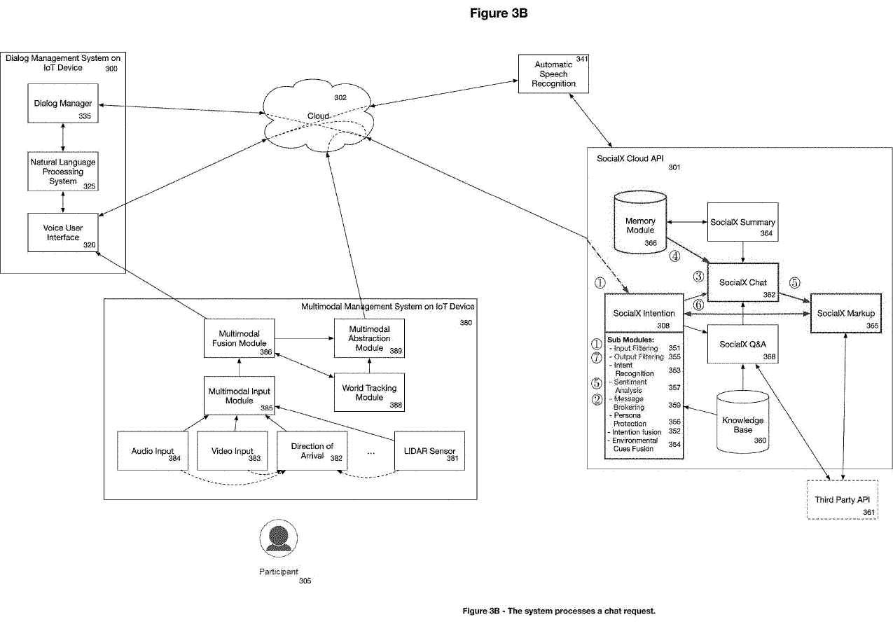

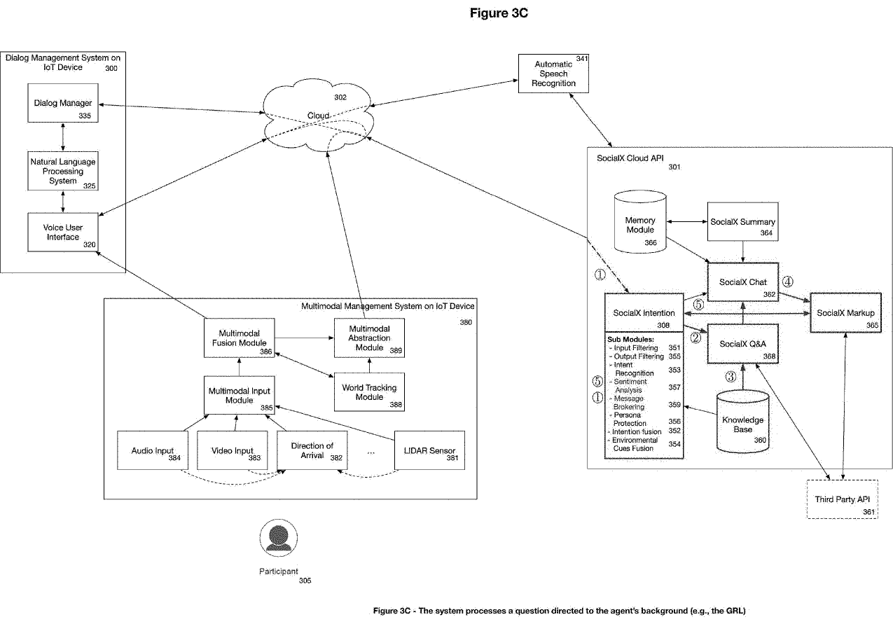

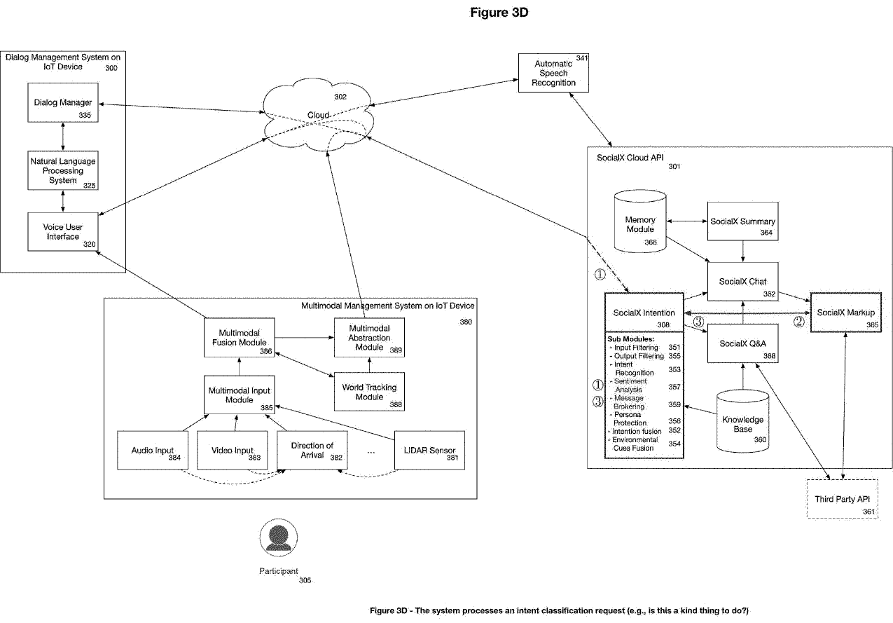

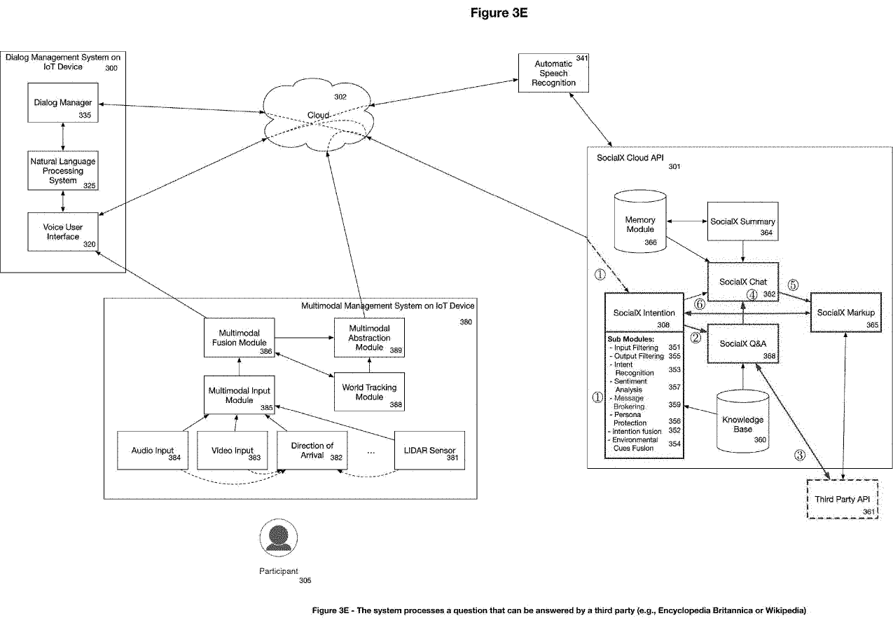

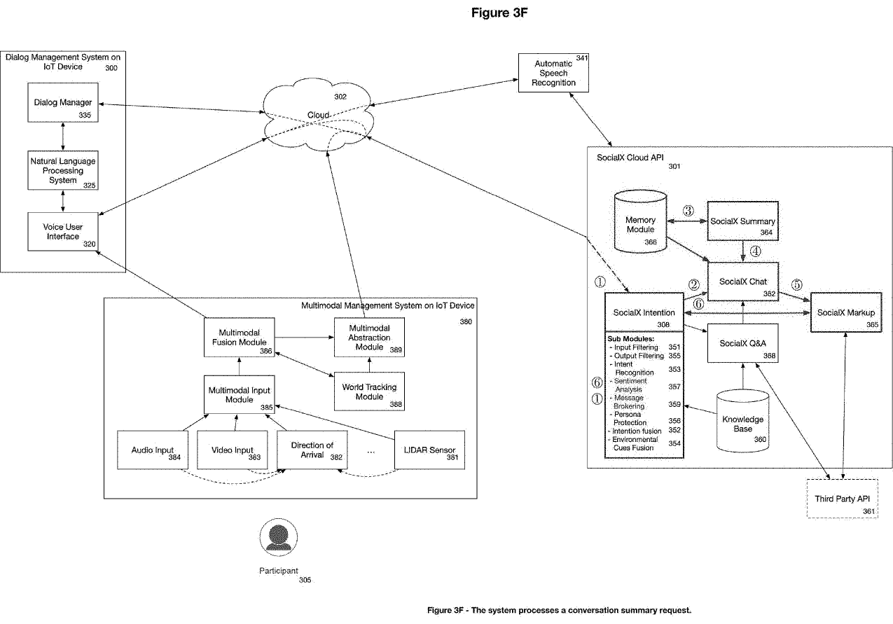

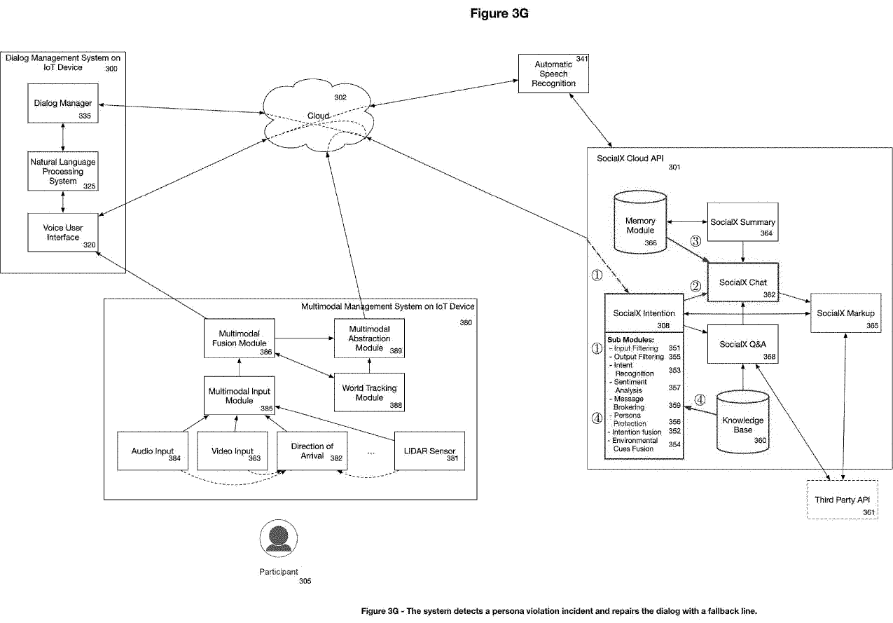

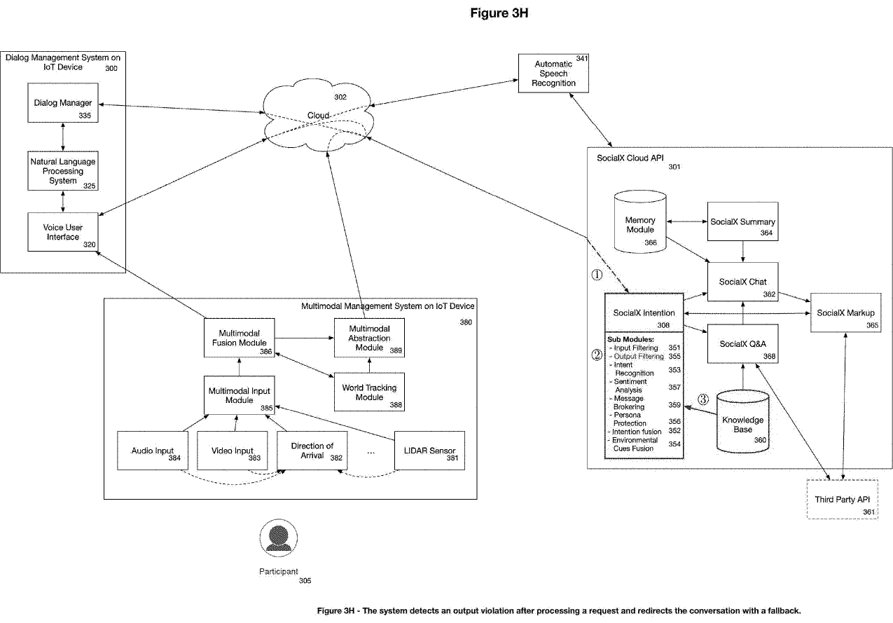

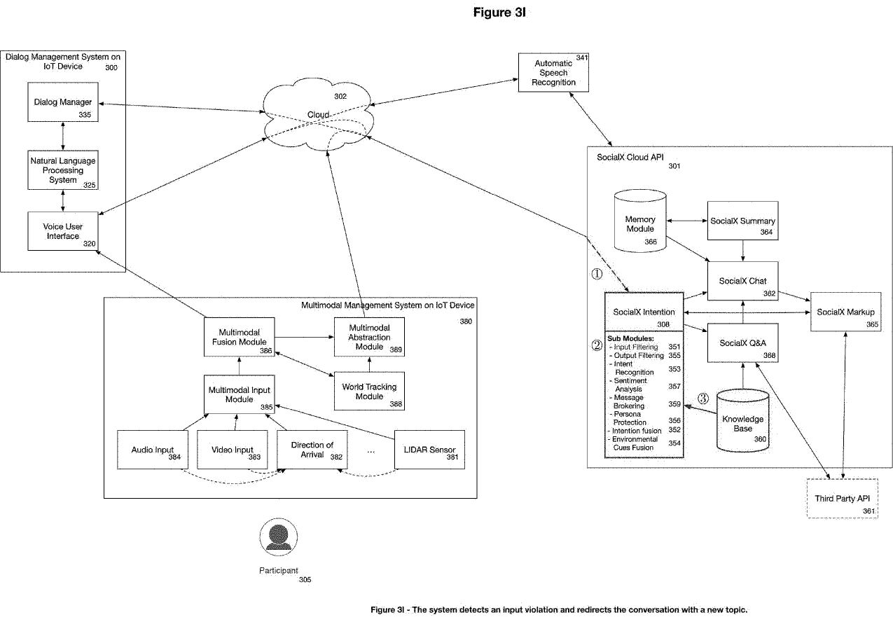

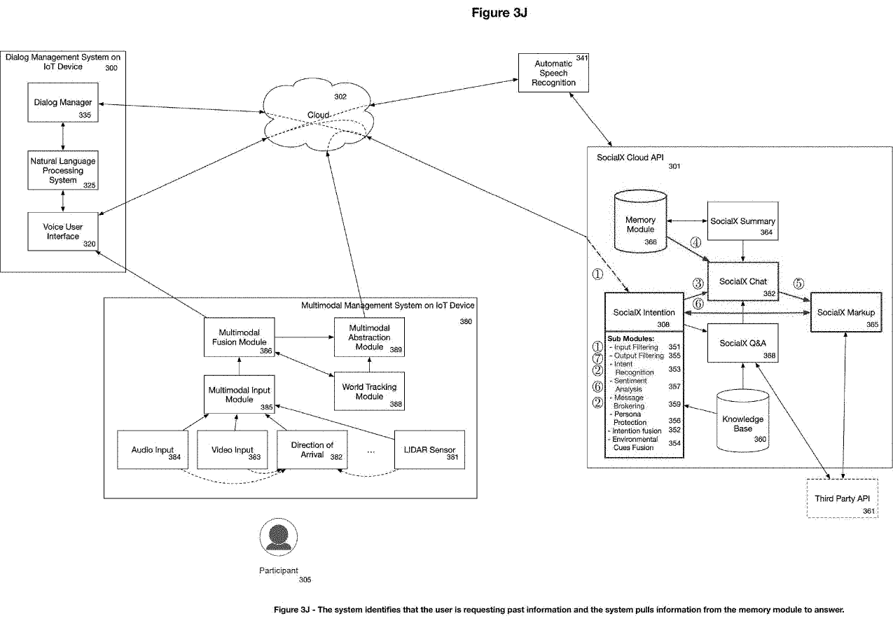

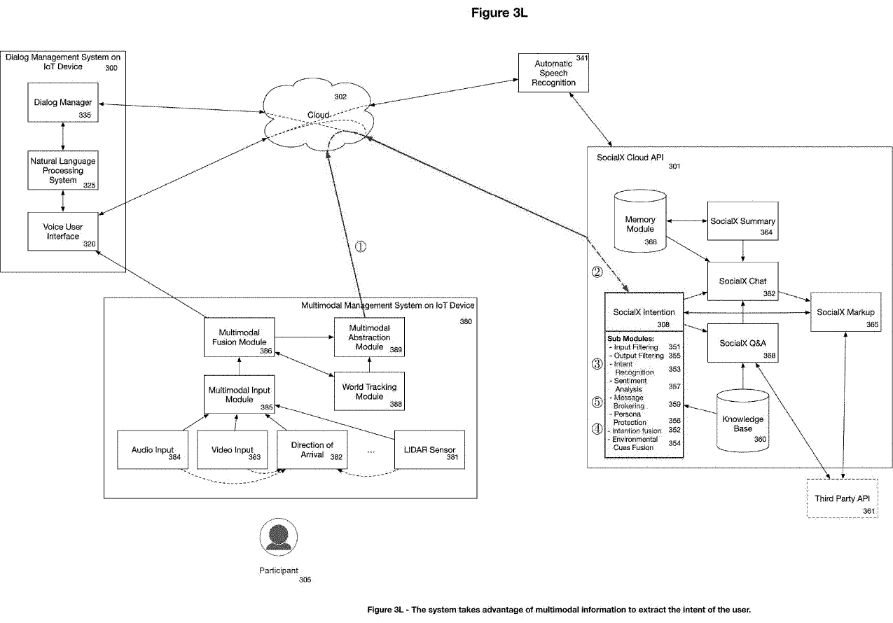

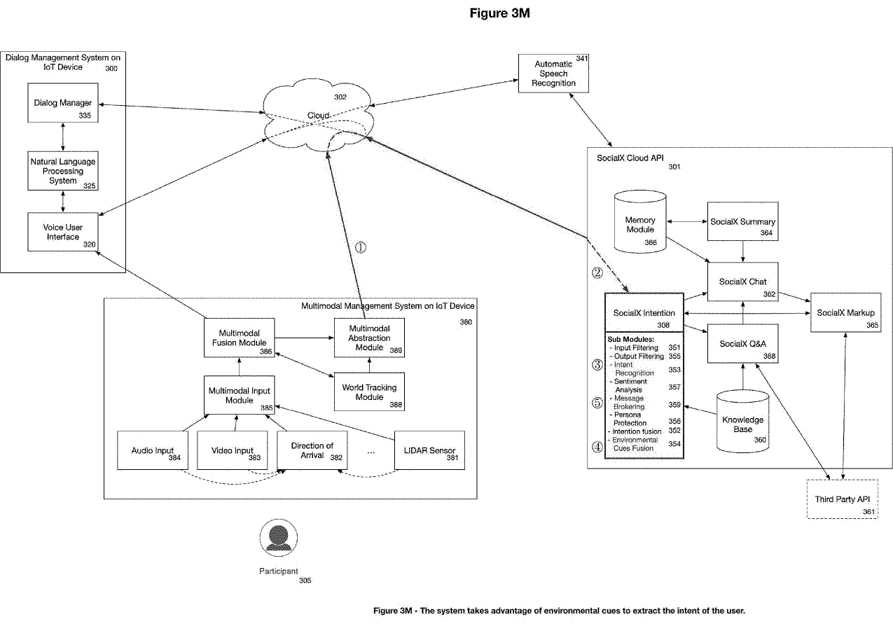

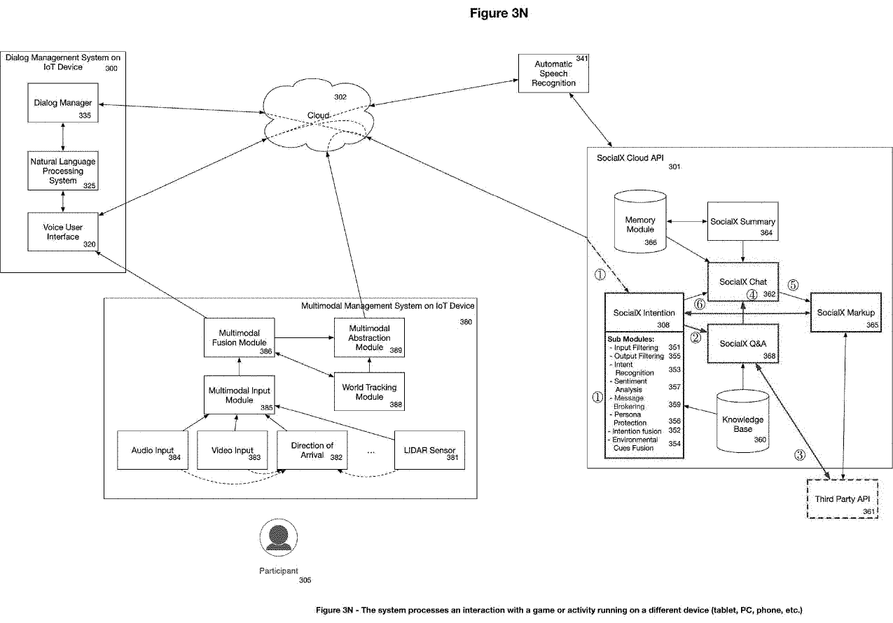

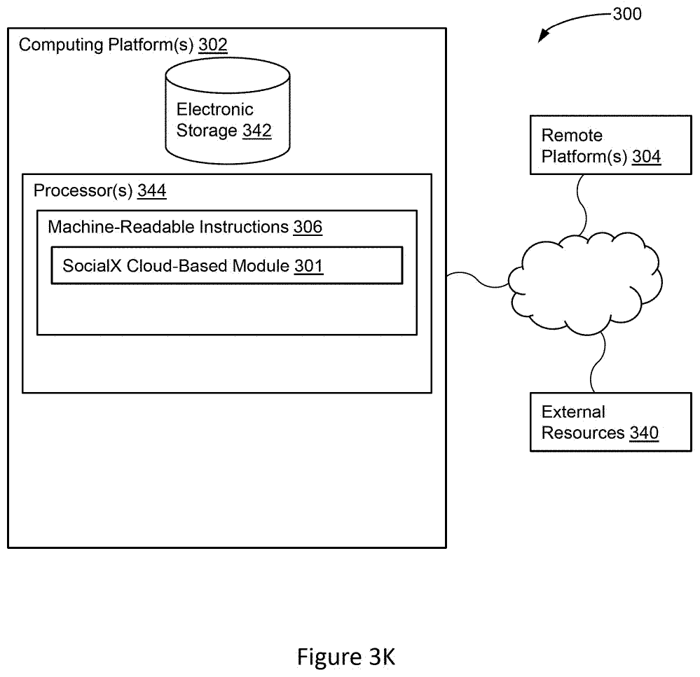

FIG. 3A illustrates a system architecture of a SocialX Cloud-based conversation System according to some embodiments. In some embodiments, a Dialog Management System 300 may be present, resident or installed in a robot computing device. In some embodiments, the dialog management system 300 on the robot computing device may include a dialog manager module 335, a natural language processing system 325, and/or a voice user interface 320. See SYSTEMS AND METHODS FOR SHORT- AND LONG-TERM DIALOG MANAGEMENT BETWEEN A ROBOT COMPUTING DEVICE/DIGITAL COMPANION AND A USER, application Ser. No. 62/983,592, filed Feb. 29, 2020. In some embodiments, the dialog management system 300 may utilize a SocialX Cloud-Based Conversation Module 301 (e.g., or application programming interface (API)) in order to more efficiently and/or accurately engage in dialog and/or conversations with a user or consumer. In some embodiments, the SocialX cloud-based conversation module 301 may be utilized in response to special commands (e.g., Moxie, let's chat), planned scheduling, special markup (e.g., an open question), a lack of or mismatched authored patterns on the robot (i.e., fallback handling), and/or complexity of the ideas or context of the one or more text files received from the speech-to-text converting module in these embodiments, the dialog management system 300 may communicate voice files to the automatic speech recognition module 341 (utilizing the cloud servers and/or network 302) and the automatic speech recognition module 341 may communicate the recognized text files to the SocialX cloud-base conversation module 301 for analysis and/or processing. While FIG. 3A illustrates that the chat or conversation module 301 is located in cloud-based computing devices, an IoT device (e.g., such as a robot device) may house and/or include the social conversation module 301.

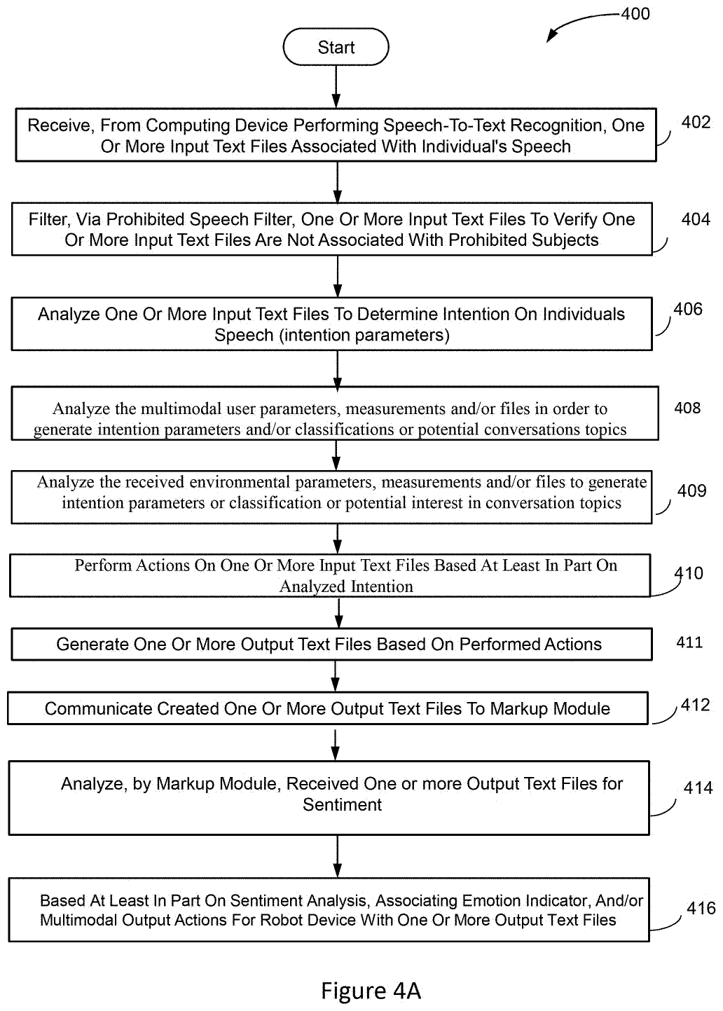

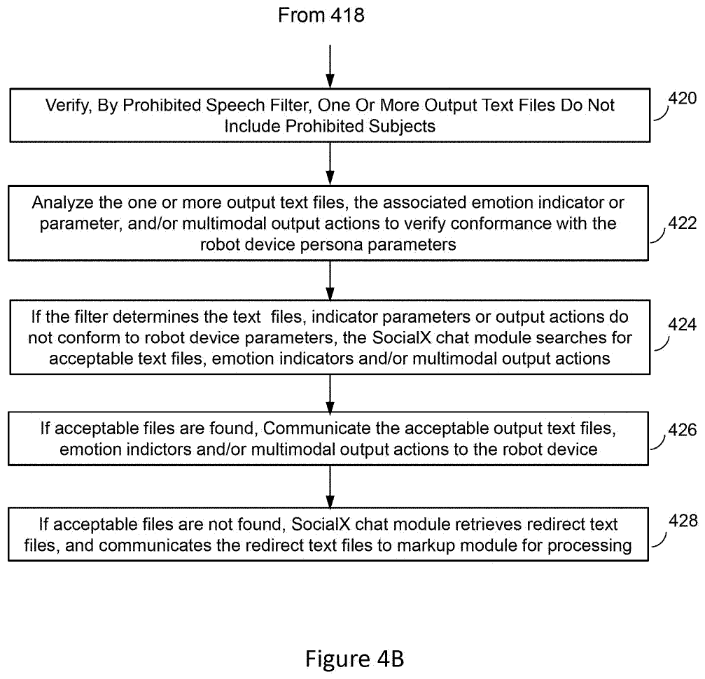

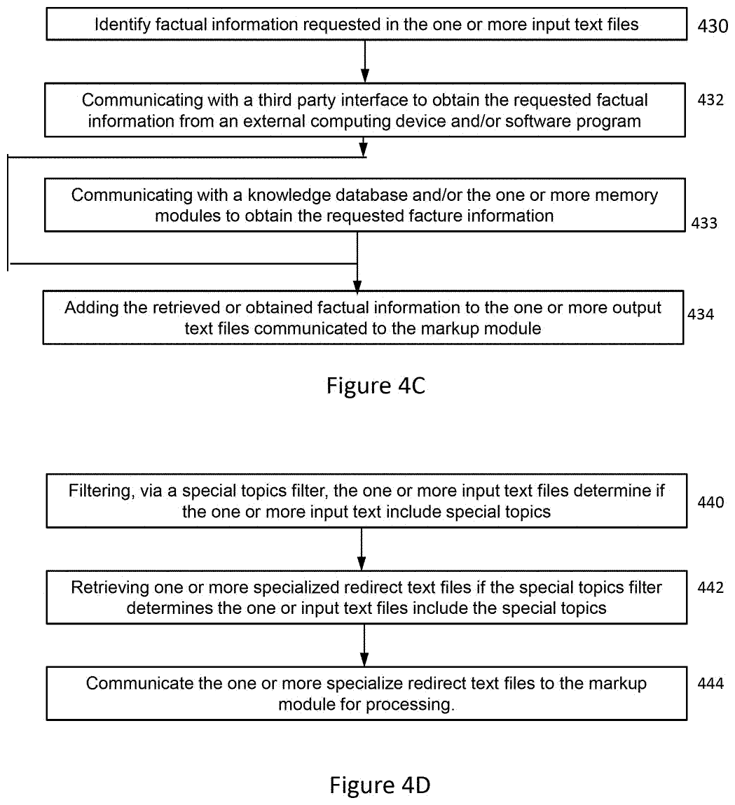

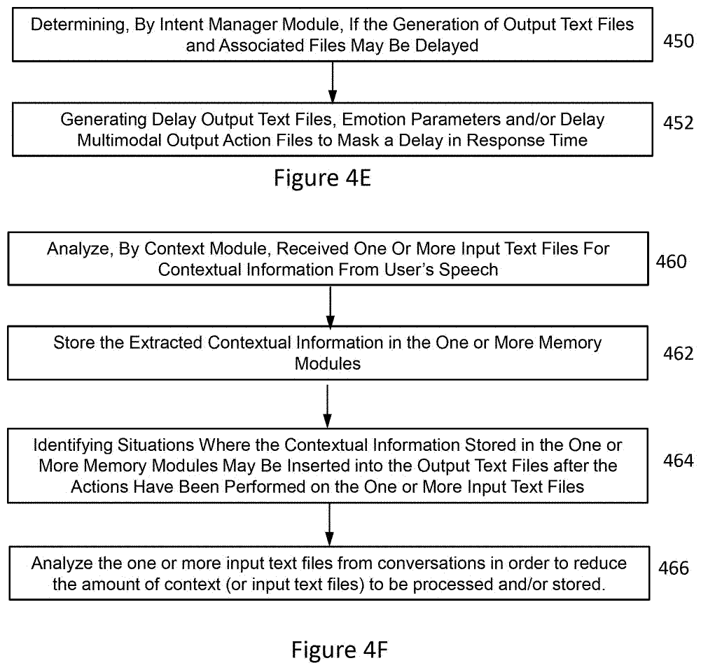

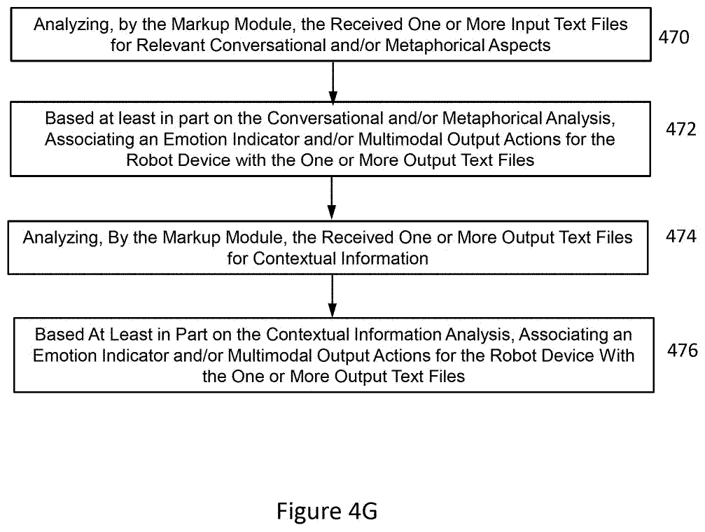

In some embodiments, the SocialX cloud-based module 301 may include one or more memory devices or memory modules 366, a conversation summary module 354 (e.g., SocialX summary module), a chat module 362 (e.g., a SocialX chat module), a conversation markup module 365 (e.g., SocialX markup module), a question and answer module 368 (e.g., a SocialX Q&A module), a knowledge base or database 360, a third-party API or software program 361, and/or an intention or filtering module 308 (e.g., SocialX intention module). In some embodiments, the intention filtering module 308 may analyze, in one and/or multiple ways, the received input text from automatic speech recognition module 341 in order to generate specific measurements and/or parameters. In some embodiments, the intention or filtering module 308 may include an input filtering module 351, an output filtering module 355, an intent recognition module 353, a sentiment analysis module 357, a message brokering module 359, a personal protection module 356, an intention fusion module 352, and/or an environmental cues fusion module 354. In some embodiments, the input filtering module 351 may include a prohibited speech filter and/or a special topics filter according to some embodiments. In some embodiment's, the third-party application software or API 361 may be located on the same cloud computing device or server as the conversation module, however, in alternative embodiments, the third party application software or API may be located on another cloud computing device or server. Interactions between the various hardware and/or software modules are discussed in detail with respect to FIGS. 3A-3N and 4A-4D below.

FIG. 3B illustrates a dataflow for processing a chat request in the SocialX Cloud-based System according to some embodiments. In some embodiments, the robot computing device may belooking for assistance in developing a conversation response to the user and/or consumer. In some embodiments, the automatic speech recognition module 341 (which may be physically separate from the SocialX cloud-based conversation module—e.g., Google's speech-to-text program) may communicate one or more input text files to the SocialX cloud-based conversation module 301 for analysis and/or processing. In some embodiments, a prohibited speech filter in the input filtering module 351 may verify the one or more input text files do not include prohibited topics (this is associated with step 404 in FIG. 4). In some embodiments, the prohibited topics may include topics regarding violence, sexual relations, sexual orientation questions and/or self-harm. Specific examples of prohibited topics include the user saying they want to hit somebody or hurt somebody, asking questions regarding sexual relations or making comments regarding the same, asking the robot the robot's sexual orientation or making comments about sexual orientation, and/or indicating that the user may be contemplating hurting themselves. Other challenging of prohibited topics that may be filtered could be politics and/or religion. In some embodiments, the one or more input text files may be analyzed by the intention recognition module 353 to determine an intent of the one or more text files and intention parameters and/or messages may be generated. for and/or associated with the one or more input text files. In some embodiments, the message brokering module 359 may communicate the one or more input text files and/or the intention parameters and/or messages to the chat module 362 (associated with step 406). As an example, the user may indicate a desire to talk about a particular topic, such as space, or school. As an additional example, the user's speech (and therefore input text files) may also show or share an interest in or alternatively, a frustration level with the current ongoing conversation. If the user input text files indicate or show frustration, this may show a willingness to change the topic of conversation (an intention parameter showing willingness to change topics). In some embodiments, a SocialX chat module 362 may analyze the one or more input text files and/or the intention parameters and/or messages to determine if any actions need to be taken based on the chat module's 362 analysis and/or the intention parameters and/or messages (associated with step 408). In some embodiments, additional modules and/or software may be utilized to analyze intention of the user. In some embodiments, the conversation module 301 may also receive multimodal parameters, measurements, and/or other input from the IoT device or robot computing device 300. In some embodiments, an intention fusion module 352 may analyze the received multimodal parameters, measurements and/or other input files (e.g., including but not limited to nonverbal cues to help analyze and/or determine the intention of the user). In some embodiments, output from the intention fusion module 352 may be utilized to help or assist in determining the intention parameters and/or messages. In some embodiments, the conversation module 301 may also receive environmental input cues from the IoT device including video or images, and/or environmental parameters and/or measurements (e.g., from the world tracking module 388 and/or multimodal fusion module 386). In some embodiments, an environmental cues fusion module 354 may analyze the received video or images, and/or environmental parameters and/or measurements to further assist in determining intention of the user. For example, if the environmental cues fusion module 354 detected an image of a toy depicting the space shuttle or a sound file including Elmo on TV, the environmental cues fusion module 354 may utilize these environmental cues to determine an interest and/or intention of the user and may assign and/or revise intention parameters and/or messages based on the received environmental cues.

In some embodiments, the chat module 362 may generate output text files (associated with step 410) and may communicate the one or more output text files to the conversation markup module 365 (associated with step 412). In some embodiments, the chat module 362 may communicate with the one or more memory devices 366 to retrieve potential output text files to add to and/or replace the generated output text files (if for example, the received and analyzed input text files include a prohibited topic). In some embodiments, a markup module 365 may utilize a sentiment analysis module 357 to analyze the sentiment and/or emotion of the output text files (associated with step 414). In some embodiments, the markup module 365 may generate and/or assign or associate an emotion indicator or parameter and/or multimodal output actions (e.g., facial expressions, arm movements, additional sounds, etc.) to the output text files (step 416). In some embodiments, the output filter module 355 may utilize a prohibited speech filter to analyze whether or not the one or more output text files include prohibited subjects (or verify that the one or more output text files do not include prohibited subjects) (associated with step 420). In other words, the input text files and the output text files may both be analyzed by a prohibited speech filter to make sure that these prohibited subjects are not spoken to the robot computing device and/or spoken by the robot computing device (e.g., both input and/or output). In some embodiments, a persona protection module 356 may analyze the one or more output text files, the associated emotion indicator or parameter(s), and/or the associated multi-modal output action(s) to verify that these files, parameter(s), and/or action(s) conform with established and/or predetermined robot device persona parameters. In some embodiments, if the guidelines are met (e.g., there is no prohibited speech topics and the output text files are aligned with the robot computing device's persona), the intention module 308 of the SocialX cloud-based module 301 may communicate the one or more output text files, the associated emotion indicator or parameter(s), and/or the associated multi-modal output action(s) to the robot computing device (associated with step 423).

If some embodiments, if the generated output text files include prohibited speech topics and/or if the generated output text files do not match with the robot computing device's persona, the chat module 362 may search for and/or locate acceptable output text files, emotion indicators or parameters, and/or multimodal output actions including topics (associated with step 424). In some embodiments, if the chat module 362 locates acceptable output text files, emotion indicators or parameters, and/or multimodal output actions, the chat module 362 and/or intention module 308 may communicate the acceptable output text files, emotion indicators or parameters, and/or multimodal output actions to the robot computing device (associated with step 426). In some embodiments, the chat module 362 cannot find or located acceptable output text files, the chat module may retrieve redirect text files from the one or more memory modules 366 and/or knowledge database 360 and communicate the redirect text files to the markup module for processing (associated with step 428).

FIG. 3C illustrates a dataflow for processing a question related to the robot's backstory according to some embodiments. As with other dataflows described herein, the intention module 308 may first perform input filtering via the input filtering module 351 (as described above in FIG. 3B); perform intention recognition via the intention recognition module 353; perform multimodal intention recognition using the intention fusion module 352 (e.g. recognizing intention (and associating intention parameters) based on analysis of the received user multimodal parameters, measurements and/or files), and perform environmental intent recognition via the environmental cues functional module 354 (e.g., recognizing intention (and associating intention parameters) based on analysis of received environmental cues, parameters, measurements and/or files (as described above in FIG. 3B). In some embodiments, in FIG. 3C, the SocialX cloud-based conversation module 301 may review the one or more input text files, determine a question was asked, find the answer to the question and then provide s response back to the robot computing device. In some embodiments, the external computing device speech recognition module 341 may communicate the one or more input text files to the intention module 308. In some embodiments, the intent recognition module 393 and/or the message brokering module 359 may analyze the one or more input text files to determine if a question about or associated with the robot computing device is present in the one or more text files. In some embodiments, if the one or more text files are directed to a question associated with the robot computing device, the message brokering module 359 may communicate the one or more input text files to the question/answer module 368. In some embodiments, the question/answer module 368 may extract the question from the one of more input text files and may query the knowledge database 360 for an answer to the question extracted from the one or more input text files. In some embodiments, the chat module 352 may generate the one or more output text files including the answer and may communicate the one or more output text files including the answer to the markup module 365. In some embodiments, the sentiment analysis module 357 may analyze the sentiment and/or emotion of the one or more output text files including the answer. In some embodiments, the markup module 365 may associate, generate and/or assign an emotion indicator(s) or parameter(s) and/or multimodal output action(s) to the output text files including the answer. From this point, the markup module 365 may perform the operations illustrated and/or described above with respect to steps 418 to 428 described in FIGS. 4A and 4B as well as the dataflow in FIG. 3B.

FIG. 3D illustrates a dataflow for processing an intent classification request according to some embodiments. In some embodiments, sometimes a child may ask a simple question that needs a simple answer that the SocialX cloud-based module may provide. For example, the user or consumer may ask whether a certain action is a kind thing to do? As with other dataflows described herein, the intention module 308 may first perform input filtering via the input filtering module 351 (as described above in FIG. 3B); perform intention recognition via the intention recognition module 353; perform multimodal intention recognition using the intention fusion module 352 (e.g. recognizing intention (and associating intention parameters) based on analysis of the received user multimodal parameters, measurements and/or files), and perform environmental intent recognition vis the environmental cues functional module 354 (e.g., recognizing intention (and associating intention parameters) based on analysis of received environmental cues, parameters, measurements and/or files (as described above in FIG. 3B). In this embodiment, the one or more input text files may be received from the external computing device automatic speech recognition module 341 and analyzed by the intent recognition module 353. In some embodiments, the intention recognition module 353 may determine an intention or classification parameter for the one or more input text files (e.g., an affirmative intention/classification, a negative intention/classification, or a neutral intention/classification) and the message brokering module 350 may generate and/or communicate the intention or classification parameter to the chat module 362. In some embodiments, the chat module 362 may generate the one or more output text files including the intention or classification parameter and may communicate the one or more output text files including the answer to the markup module 365. In some embodiments, the sentiment analysis module 357 may analyze the sentiment and/or emotion of the one or more output text files including the intention or classification parameter. In some embodiments, the markup module 365 may associate, generate and/or assign an emotion indicator(s) or parameter(s) and/or multimodal output action(s) to the output text files including the intention of classification parameter. From this point, the markup module 365 may perform the operations illustrated and/or described above with respect to steps 418 to 428 described in FIGS. 4A and 4B as well as the dataflow in FIG. 3B.

FIG. 3E illustrates a dataflow for answering a question by a third-party application according to some embodiments. For example, the SocialX cloud-based conversation module 301 may need to refer to an external or a third-party software application for answers to the questions being answered. For example, the cloud-based conversation module 301 may need to refer to Encyclopedia Britannica for an answer about what specific words means and/or referring to a third-party software coding program for an answer or guidance about software coding. As with other dataflows described herein, the intention module 308 may first perform input filtering via the input filtering module 351 (as described above in FIG. 3B); perform intention recognition vis the intention recognition module 353; perform multimodal intention recognition using the intention fusion module 352 (e.g. recognizing intention (and associating intention parameters) based on analysis of the received user multimodal parameters, measurements and/or files), and perform environmental intent recognition via the environmental cues functional module 354 (e.g., recognizing intention (and associating intention parameters) based on analysis of received environmental cues, parameters, measurements and/or files (as described above in FIG. 3B). In some embodiments, a message brokering module 359 may receive the one or more input text files. In some embodiments, the intent recognition module 353 and/or the message brokering module 359 analyzes the one or more input text files to determine that a question is being asked and communicates the one or more text files to the question/answer module 368. In some embodiments, the question/answer module 368 may extract the question from the one or more input text files and may communicate with the third-party application programming interface or software 361 to obtain an answer for the extracted question. In some embodiments, the question/answer module 368 may receive one or more answer text files for the third party API or software and may communicate the one or more answer text files to the chat module 362. In some embodiments, the chat module 362 may generate one or more output text files including the one or more answer text files and communicate the one or more output text files including the one or more answer files to the conversation markup module 365. From this point, the markup module 365 may perform the operations described above with respect to FIG. 3B. From this point, the markup module 365 may perform the operations illustrated and/or described above with respect to steps 418 to 428 described in FIGS. 4A and 4B as well as the dataflow in FIG. 3B.

FIG. 3F illustrates a dataflow for processing a conversation summary request according to some embodiments. A user or consumer may desire to receive a conversation summary request of one or more conversations that have occurred between the robot computing device and/or the user or consumer. In some embodiments, the SocialX cloud-based conversation module 301 may receive the one or more input text files. As with other dataflows described herein, the intention module 308 may first perform input filtering via the input filtering module 351 (as described above in FIG. 3B); perform intention recognition via the intention recognition module 353; perform multimodal intention recognition using the intention fusion module 352 (e.g. recognizing intention (and associating intention parameters) based on analysis of the received user multimodal parameters, measurements and/or files), and perform environmental intent recognition via the environmental cues functional module 354 (e.g., recognizing intention (and associating intention parameters) based on analysis of received environmental cues, parameters, measurements and/or files (as described above in FIG. 3B). In some embodiments, the message brokering module 359 may analyze the one or more input text files and identify that the one or more input text files are requesting a summary of conversations with the user or consumer and may communicate the summary request to the chat module 362. In some embodiments, upon being notified of the summary request, the conversation summary module 364 may communicate with the one or more memory modules 366 and retrieve the prior conversation text files between the robot computing device and/or the user and/or consumer. In some embodiments, the conversation summary module 364 may summarize the prior conversation text files and generate one or more conversation summary text files. In some embodiments, the conversation summary module 364 may communicate the one or more conversation summary files to the chat module 362 which may generate one or more output text files including the conversation summary text files to the conversation markup module 365. From this point, the markup module 365 may perform the same operations described above with respect to FIG. 3B. From this point, the markup module 365 may perform the operations illustrated and/or described above with respect to steps 414 to 428 described in FIGS. 4A and 4B as well as the dataflow in FIG. 3B.

FIG. 3G illustrates a dataflow for processing and dealing with a persona violation incident according to some embodiments. The SocialX cloud based conversation module 301 may also review the one or more input text files and/or the one or more output text files for robot persona violations. In other words, the robot computing device may have specific characteristics, behaviors and/or actions which may be referred to as a robot personal. If the incoming one or more text files or the one or more output text files, associated emotion parameters and/or indicators, and/or multimodal output actions violate these personal violations (e.g., have different characteristics of behaviors), or are significantly different than these robot computing device characteristics, behaviors and/or actions, the SocialX cloud-based conversation module 301 may identify this has occurred. FIG. 3G is focused on analyzing the one or more input text files for a robot persona violation. As with other dataflows described herein, the intention module 308 may first perform input filtering via the input filtering module 351 (as described above in FIG. 3B); perform intention recognition via the intention recognition module 353; perform multimodal intention recognition using the intention fusion module 352 (e.g. recognizing intention (and associating intention parameters) based on analysis of the received user multimodal parameters, measurements and/or files), and perform environmental intent recognition via the environmental cues functional module 354 (e.g., recognizing intention (and associating intention parameters) based on analysis of received environmental cues, parameters, measurements and/or files (as described above in FIG. 3B). In some embodiments, the input filtering module 351 analyzes the received one or more input text files and communicates and communicates the one or more input text files to the chat module 362. In some embodiments, the chat module 362 may communicate with the one or more memory devices 366 to retrieve the robot computing device's persona. In some embodiments, the persona protection module 356 may utilize the retrieved robot computing device's persona to analyze of determine the received one or more input text files to determine if the received one or more input text files violate the retrieved persona parameters (e.g., characteristics, behaviors and/or actions). If the persona protection module 356 determines the received one or more input text files violate the retrieved persona parameters, the persona protection module 356 and/or the intention module 308 communicates with the knowledge database 360 to retrieve one or more fallback, alternative and/or acceptable input text files which replace the received input text files (which violated the robot computing device's persona parameters). In some embodiments, the one or more fallback, alternative and/or acceptable input text files are then processed by the char module 362, which generates the one or more output text files. Persona parameters (e.g., characteristics, behaviors and/or actions may include user persona parameters, robot or IoT persona parameters, or overall general persona parameters. As examples, the user persona parameters may include preferred color, sports, food, music, pets, hobbies, nickname, etc. which may be input by the user and/or collected by the robot or IoT computing device during conversations with the user. In some embodiments, the robot persona parameters may include attitude (e.g., friendly, goofy, positive) or other characteristics (activities that it cannot perform due its physical limitations, subject matter limitations, or that it is not an actual living being). Examples of robot persona parameters include the robot or IoT computing device does not eat french fries, it cannot play soccer, or have a pet or have children, and cannot say it goes to the moon or another planet (although it is a global ambassador for the GRL). The personal parameters may also depend on a use case. For example, different robot persona parameters may be necessary for elderly care robots, teenager directed robots, therapy robots and/or medical robots. In some embodiments, the chat module 362 may communicate the one or more output text files and/or associated intention parameters or classifications to the markup module 365. From this point, the markup module 365 may perform the operations illustrated and/or described above with respect to steps 414 to 428 described in FIGS. 4A and 4B as well as the dataflow in FIG. 3B.

FIG. 3H illustrates a dataflow for processing an output violation incidence of occurrence according to some embodiments. The output violation may be that the output text files 1) violates or are significantly different from robotic computing device's persona parameters; 2) includes prohibited speech topics; and/or 3) includes other topics that the robot computing device should not be conversing about (e.g., social injustice or mental health). In these embodiments, the operations described in steps 402-416 (and illustrated in FIG. 3B) may be performed. In these embodiments, an output filter module 355 may receive the one or more output text files, associated emotion parameters and/or indicators, and/or multimodal output actions and analyzes these to determine if one of the output violations listed above have occurred (e.g., a prohibited speech filter is utilized, a special topics filter is utilized, and/or a persona protection filter may be utilized to analyze and/or evaluate the one or more output text files, associated emotion parameters and/or indicators, and/or multimodal output actions). If a violation is determined to have occurred (e.g., a prohibited speech topic is included in the one or more output text files or the persona parameters are not followed by the output text files, emotion parameters and/or multimodal output actions), the output filter module 355 may communicate with the intention module 308 that the persona violation has occurred and the intention module 308 may communicate with the knowledge database 360 to retrieve one or more acceptable output text files. In some embodiments, the one or more acceptable output text files are communicated to the markup module 365 so that emotion parameters and/or multimodal output actions may be associated and/or assigned to the one or more acceptable output text files. In some embodiments, the markup module may communicate the one or more acceptable output text files, emotion parameters and/or multimodal output actions to the chat module 362. In some embodiments, the knowledge database 360 may store the one of more acceptable output text files, associated emotion parameters and/or multimodal output actions. In some embodiments, the chat module 362 and/or the intention module 308 may provide one or more acceptable output text files, associated emotion parameters and/or multimodal output actions to the dialog manager in the robot computing device 300.

FIG. 3I illustrates a dataflow for an input speech or text violation incidence or occurrence according to some embodiments. In some embodiments, the input speech or text violations may be that the input speech or text includes social justice topics, self harm topics, mental health topics, violence topics and/or sexual relations topics. In some embodiments, the intention module 308 may receive the one or more input text files from the automatic speech recognition module 341. In these embodiments, the input filter 351 of the intention module 308 may analyze the one or more input text files to determine if any of the text violations or occurrences listed above are present in the one or more input text files received from the automatic speech recognition module 341. In some embodiments, if a violation has occurred, the intention module 308 and/or the message brokering module 359 may communicate with and retrieves one or more acceptable and/or new text files from the knowledge database 360. In these embodiments, the retrieved one or more acceptable and/or new text files do not include any of the topics listed above. In some embodiments, the message brokering module 359 may communicate the retrieved one or more acceptable text files to the chat module 362 and the chat module may communicate the one or more acceptable text files to the markup module 365 for processing and/or analysis. From this point, the markup module 365 may perform the operations illustrated and/or described above with respect to steps 414 to 428 described in FIGS. 4A and 4B as well as the dataflow in FIG. 3B. In some alternative embodiments, the retrieved one or more acceptable text files may be analyzed by the message broker module 359 to determine which additional module in the SocialX cloud-based module 301 may further process the retrieved one or more acceptable text files.

FIG. 3I illustrates a dataflow for processing a request for past information about the robot and/or consumer communication according to some embodiments. Sometimes a user or consumer is requesting past information about conversations and/or activities that the user or consumer have engaged in with the robot computing device. The SocialX cloud-based conversation module 301 may retrieve this past information which is stored in the one or more memory modules 366. In some embodiments, the input filter 351 of the intention module 308 may analyze the one or more text files to determine if any text violation or persona violation has occurred (as is discussed above with respect to steps 402-406 of FIG. 4 and FIGS. 3B and 3I). In some embodiments, the robot computing device may analyze received user multimodal parameters, measurements and/or files (as described below in FIG. 3M) in order to determine intention parameters or conversation topics and/or may analyze received environmental cues, parameters, measurements and/or files (as described below in FIG. 3M) to determine intention parameters or conversation topics. In some embodiments, the message broker module 359 analyzes the one or more text files and determines that the one or more input text files are to be communicated to the chat module 362 because the one or more input text files are requesting past information about conversations and/or activities that the user has engage in. In some embodiments, the chat module 362 may communicate with the one or more memory modules 366 and/or retrieve past information above conversations and/or activities in the form of one or more past information text files. In some embodiments, the chat module 362 may communicate the one or more past information text files to the markup module 365. In some embodiments, the markup module 365 may associate one or more emotion parameters and/or multimodal output actions with the past information text files after the sentiment analysis module 357 determines an emotion associated with the past information text files. From this point, the markup module 365 may perform the same operations described above with respect to steps 418-428 of FIGS. 4A and 4B and illustrated in FIG. 3B.

FIG. 3K illustrates a system 300 configured for establishing or generating multi-turn communications between a robot device and an individual, in accordance with one or more implementations. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304. One or more components described in connection with system 300 may be the same as or similar to one or more components described in connection with FIGS. 1A, 1B, and 2. For example, in some implementations, computing platform(s) 302 and/or remote platform(s) 304 may be the same as or similar to one or more of the robot computing device 105, the one or more electronic devices 110, the cloud server computing device 115, the parent computing device 125, and/or other components.

Computing platform(s) 302 may be configured by machine-readable instructions 306. Machine-readable instructions 306 may include one or more instruction modules. The instruction modules may include computer program modules. The instruction modules may include a SocialX cloud-based module conversation 301.

SocialX cloud-based conversation module 301 may be configured to receive, from a computing device performing speech-to-text recognition, one or more input text files associated with the individual's speech, may analyze the one or more input text files to determine further actions to be taken, may generate one or more output text files, and may associate emotion parameter(s) and/or multimodal action files with the one or more output text files and may communicate the one or more output text files, the associated emotion parameter(s), and/or the multi-modal action files to the robot computing device.

In some implementations, an open question may be present. In some implementations, there is a lack of may match existing conversation patterns on the robot device in order to determine whether or not to utilize the cloud-based social chat modules. In some implementations, the social chat module searches for acceptable output text files, associated emotion indicators, may and/or multimodal output actions in a knowledge database 360 and/or the one or memory modules 366.

In some implementations, computing platform(s) 302, remote platform(s) 304, and/or external resources 340 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 340 may be operatively linked vis some other communication media.

A given remote platform 304 may include one or more processors configured to execute computer program modules. The computer program modules may be configured to enable an expert or user associated with the given remote platform 304 to interface with system 300 and/or external resources 340, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 340 may include sources of information outside of system 300, external entities participating with system 300, and/or other resources. In some implementations, some or all of the functionality attributed herein to external resources 340 may be provided by resources included in system 300.

Computing platform(s) 302 may include electronic storage 342, one or more processors 344, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 342 may comprise non-transitory storage media that electronically stores information. The electronic storage media of electronic storage 342 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 342 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 342 may include one or more virtual storage resources (e.g., cloud storage, a virtual private network, and/or other virtual storage resources). Electronic storage 342 may store software algorithms, information determined by processor(s) 344, information received from computing platform(s) 302, information received from remote platform(s) 304, and/or other information that enables computing platform(s) 302 to function as described herein.

Processor(s) 344 may be configured to provide information processing capabilities in computing platform(s) 302. As such, processor(s) 344 may include one or more of a digital processor, an analog processor, a digital circuit designed to process information, an analog circuit designed to process information, a state machine, and/or other mechanisms for electronically processing information. Although processor(s) 344 is shown in FIG. 3 as a single entity, this is for illustrative purposes only. In some implementations, processor(s) 344 may include a plurality of processing units. These processing units may be physically located within the same device, or processor(s) 344 may represent processing functionality of a plurality of devices operating in coordination. Processor(s) 344 may be configured to execute modules 308, and/or other modules. Processor(s) 344 may be configured to execute modules 308 and/or other modules by software, hardware; firmware; some combination of software, hardware, and/or firmware; and/or other mechanisms for configuring processing capabilities on processor(s) 344. As used herein, the term “module” may refer to any component or set of components that perform the functionality attributed to the module. This may include one or more physical processors during execution of processor readable Instructions, the processor readable instructions, circuitry, hardware, storage media, or any other components.

It should be appreciated that although modules 301 are illustrated in FIG. 3K as being implemented within a single processing unit, in implementations in which processor(s) 344 includes multiple processing units, one or more of modules 301 may be implemented remotely from the other modules. The description of the functionality provided by the different modules 301 described below is for illustrative purposes, and is not intended to be limiting, as any of modules 301 may provide more or less functionality than is described. For example, one or more of modules 301 may be eliminated, and some or all of its functionality may be provided by other ones of modules 301. As another example, processor(s) 344 may be configured to execute one or more additional modules that may perform some or all of the functionality attributed below to one of modules 301.

FIG. 3L illustrates utilization of multimodal intent recognition in the conversation module according to some embodiments. In some embodiments, the SocialX Intention module 308 recognizes an intention of the user by taking advantage of additional cues other than the text provided by the voice user interface 320. In some embodiments, the multimodal abstraction module 389 may provide non-verbal user measurements, files and/or parameters to the SocialX intention module 308. In these embodiments, the intent recognition module 363 may parse and/or analyze the information from the Voice User Interface 320 and the automatic speech recognition module 341 (e.g., the one or more text input files). In these embodiments, the intention Fusion module 352 may utilize the analysis from the intent recognition module 363 and/or may analyze the received user multimodal parameters, measurements and/or files from the multimodal abstraction module 389 to further determine intention of the user. As an example, the intention fusion module 352 may analyze the received user multimodal parameters, measurements and/or files (e.g., face expression of voice tone indicates that the user is frustrated with the conversation and there is a need to change topic, or the face expression and the tone of the voice shows that the user is very anxious) and may determine that it may be useful so to provide some soothing conversation). In this embodiment, the intention fusion module 352 may generate intention classifications or parameters to the message brokering module 359 which may then provide the one or more input text files, the intention classification of parameters and/or the multimodal parameters measurements or files to the chat module 362. In some embodiments, the operations may then proceed as outlined in steps 410 to 428 of FIGS. 4A and 4B.

FIG. 3M illustrates utilization of environmental cues, parameters, measurements or files for intent recognition according to some embodiments. In some embodiments, FIG. 3M showcases the usage of the environmental cues for intent recognition. The SocialX intention module recognizes the intention of the user by taking advantage of additional environmental CUES, parameters, measurements and/or files other than the text provided by the voice user interface. In some embodiments, the multimodal abstraction module 389 may provide non-verbal environmental cues, measurements, files and/or parameters to the intention module 308. In these embodiments, the intent recognition module 363 may parse and/or analyze the information from the Voice User Interface 320 and the automatic speech recognition module 341 (e.g., the one or more text input files). In these embodiments, the environmental cues fusion module 354 may utilize the analysis from the intent recognition module 363 and/or may analyze the received multimodal environmental cues, parameters, measurements and/or files from the multimodal abstraction module 389 to further determine intention of the user. As an example, the environmental cues fusion module 354 may analyze the received multimodal environmental cues, parameters, measurements and/or files (e.g., detecting an image of a toy depicting the space shuttle or hearing Elmo on a TV in the room or area of the user, it is an indication of a potential interest of the user on these topics of conversation and may determine these conversation topics could be utilized). In this embodiment, the environmental cues fusion module 352 may generate intention classifications or parameters identifying a conversation topic and may communicate the intention classifications of parameters to the message brokering module 359, which may then provide the one or more input text files, the intention classification or parameters and/or the multimodal environmental cues, parameters, measurements and/or files to the chat module 362. In some embodiments, the operations may then proceed as outlined in steps 410 to 428 of FIGS. 4A and 4B. FIG. 3N illustrates a third-party computing device that a user is engaged with providing answer to questions according to some embodiments. FIG. 3N indicates a variation of the example depicted in FIG. 3E, except the user and/or robot computing device (or IoT computing device) is actively engaged with the third-party computing device. In some embodiments, the third-party computing device may be running or executing a game or activity program. In some embodiments, the third-party computing device 399 may include, but is not limited to the Global Robotics Laboratory (GRL) website or portal (where the user may play games or perform activities) or the GRL Playzone website or portal. In some embodiments, the third-party computing device may include a therapy website where a user or patient is engaged in activities under the control of a therapist or a medical professional. In some embodiments, the user may have another computing device (e.g., (tablet, PC, phone, etc.)) and the third party API may connect to either the user computing device or the third-party computing device in order to assist in defining conversation topics and/or providing answers to questions from the user. Figure N illustrates a dataflow for answering a question by a third-party application running on a third-party computing device (or another user computing device) according to some embodiments. For example, the SocialX cloud-based conversation module 301 may need to refer to an external or a third-party software application running on the third-party computing device 399 or other user computing device (that is interacting with the IoT or robot computing device 300) for answers to the questions being answered. For example, the cloud-based conversation module 301 may need to refer to the Global Robotics Laboratory website or portal for answers about the GRL portal, activities in the GRL portal, or characters in the GRL portal. As with other dataflows described herein, the intention module 308 may first perform input filtering via the input filtering module 351 on the one or more input text files and/or the input multimodal parameters, measurements or files (as described above in FIG. 3B) and/or perform intention recognition vis the intention recognition module 353, the intention fusion module 352, and/or the environmental cues functional module 354 (as described above in FIG. 3B). In some embodiments, a message brokering module 359 may receive the one or more input text files. In some embodiments, the intent recognition module 353 and/or the message brokering module 359 analyzes the one or more input text files to determine that a question is being asked and communicates the one or more text files to the question/answer module 368. In some embodiments, the question/answer module 368 may extract the question or query from the one of more input text files and may communicate with the third-party application programming interface or software to the third party computing device 399 to obtain an answer for the extracted question. In some embodiments, the question/answer module 368 may receive one or more answer text files from the third-party computing device and may communicate the one or more answer text files to the chat module 362. In some embodiments, the chat module 352 may generate one or more output text files including the one or more answer text files and communicate the one or more output text files including the one or more answer files to the conversation markup module 365. From this point, the markup module 365 may perform the operations described above with respect to FIG. 3B. From this point, the markup module 365 may perform the operations illustrated and/or described above with respect to steps 418 to 428 described in FIGS. 4A and 4B as well as the dataflow in FIG. 3B.

FIG. 4A illustrates a method 400 for utilizing a cloud-based conversation module to establish multi-turn communications between a robot device and an individual, in accordance with one or more implementations. FIG. 4B further illustrates a method for utilizing a cloud-based conversation module to establish multi-turn communications between a robot device and an individual, in accordance with one or more implementations. The operations of method 400 presented below are intended to be illustrative. In some implementations, method 400 may be accomplished with one or more additional operations not described, and/or without one or more of the operations discussed, Additionally, the order in which the operations of method 400 are illustrated in FIG. 4a and described below is not intended to be limiting and may be performed in a different order than presented in FIG. 4A. (Include that one or more of the operations may be performed on incoming text files).

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

In some embodiments, an operation 402 may include receiving, from a computing device performing speech-to-text recognition 341, one or more input text files associated with the individual's speech. Operation 402 may be performed by one or more hardware processors configured by machine-readable instructions including a module that is the same as or similar to SocialX cloud-based conversation module 301, in accordance with one or more implementations. In an alternative embodiment, an automatic speech recognition module 341 may not utilize the SocialX cloud-based conversation module 301 and instead the text may be sent to the dialog manager module 335 for processing. As discussed previously, utilizing the SocialX cloud-based conversation module may be triggered by special commands, lack of matching with known patterns, if an open question is present or if a communication between participating devices and/or individuals is too complex.

In some embodiments, an operation 404 may include filtering, via a prohibited speech filter module (which may also be referred to as input filtering module) 351, the one or more input text files to verify the one or more input text files are not associated with prohibited subjects or subject matter. Operation 404 may be performed by one or more hardware processors configured by machine-readable instructions including a module that is the same as or similar to a prohibited speech filter module/input filtering module 351 in an intention module 308, in accordance with one or more implementations. In some embodiments, prohibited subjects and/or subject matter may include topics such as violence, sex and/or self-harm. In some embodiments, if the prohibited speech filter module determines that the one or more input text files are associated with prohibited subject matter, the intention module 308 and prohibited speech filter module/input filtering module 351 may communicate with a knowledge database 360 in order to retrieve safe one or more output text files. In some embodiments, the intention module 308 and/or the message brokering module 359 may communicate the one or more retrieved safe output text files to the chat module 362 for processing. In some embodiments, the one or more safe text files may provide instructions for the robot computing device to speak phrases such as “Please, talk to a trusted adult about this” or “That is a topic I don't know much about” and/or also “Would you like to talk about something else.” In some embodiments, in operation 444, the chat module 362 may communicate the one or more specialized redirect text files to the markup module 354 for processing.

In some embodiments, an operation 406 may include analyzing the one or more input text files to determine an intention on the individual's speech as identified in the input text files. In some embodiments, intention parameters and/or classifications may be associated and/or assigned to the one or more input text files based, at least in part, on the analysis. In some embodiments, the one or more text files and/or the intention parameters and/or classifications may be communicated to the message brokering module 359. Operation 406 may be performed by one or more hardware processors configured by machine readable instructions including a module that is the same as of similar to intention recognition module 353, in accordance with one or more implementations. Intention fusion module—In some embodiments, an operation 408 may include receiving multimodal user parameters, measurements and/or files from the multimodal abstraction module 389 (in addition to the one or more text files) to assist in determining an intention of the user and/or a conversation topic that which the user may be interested in. In these embodiments, the intention fusion module 352 may analyze the multimodal user parameters, measurements and/or files in order to generate intention parameters and/or classifications or potential conversations topics. In some embodiments, the intention fusion module 352 may communicate the one or more input text files, the intention parameters and/or classifications or potential conversation topics to the message brokering module 350 which in turn communicates the one or more input text files, the intention parameters and/or classifications or potential conversation topics to the chat module 362. As an example, the multimodal abstraction module 359 may communicate multimodal intention parameters or files (such as an image that the user is smiling and shaking their head up and down or parameters representing the same) to the intention fusion module 352 which may indicate the user is happy. In this example, the intention fusion module 352 may generate intention parameters or measurements identifying that the user is happy and engaging. In an alternative embodiment, the multimodal abstraction module 359 may communicate multimodal intention parameters or files (such as an image showing the user's hands up in the air and/or the user looking confused or parameters representing the same) and the intention fusion module 352 may receive these multimodal intention parameters or files and determine that the user is confused. In these embodiments, the intention fusion module may generate intention parameters or classifications identifying that the user is confused.

Environmental cues fusion module—In some embodiments, an operation 409 may include receiving multimodal environmental parameters, measurements and/or files from the multimodal abstraction module 389 and/or world tracking module 388 (in addition to the one or more text files) to assist in determining an intention of the user and/or conversation topics the user may be interested in. In these embodiments, the environmental cues fusion module 354 may analyze the received environmental parameters, measurements and/or files to generate intention parameters or classification of potential interest in conversation topics. In these embodiments, the environmental cues fusion module 354 may communicate the one or more text files and/or the generated intention parameters or classifications or potential interest in conversation topics to the message brokering module 359 which in turn may communicate this information to the correct module (e.g., the chat module 362 or the question & answer module 368. As an example, the user may be walking to a pet like his or her dog and saying “Come here spot” and the multimodal abstraction module 389 may communicate the environmental parameters, measurements and/or files with this image or parameters representing these images and sounds to the environmental cues fusion module 354. In this example, the environmental cues fusion module 354 may analyze the environmental parameters and/or images and the user's statement and identify that the user may be receptive to talk about their dog. In this example, the environmental cues fusion module 354 may generate intention parameters or classifications or conversation topics indicating the dog topic and may communicate these intention parameters, classifications or conversation topics to the message brokering module 359. As another example, the user may be in a crowded area with lots of noise and everyone wearing a football jersey and the multimodal abstraction module 389 and/or world tracking module 388 may generate environmental parameters, measurements and/or files that are transmitted to the conversation cloud module 301 and specifically the environmental cues fusion module 354. In this example, the environmental cues fusion module 354 may analyze the received environmental parameters, measurements and/or files and identify that the user may be receptive to talking about football and may also need to move to another area with less people due to the noise and therefore may generation intention parameters, classifications and/or topics with respect associated with football topics and/or moving to a quieter place. In some embodiments, the environmental cues fusion module 354 may communicate the generated intention parameters, classifications and/or topics to the message brokering module.

In some embodiments, an operation 410 may include performing actions on the one or more input text files based at least in part on the analyzation and/or understanding of the one or more input text files and/or the received intention parameters, classifications and/or topics. Operation 410 may be performed by one or more hardware processors configured by machine-readable instructions including a module that is the same as or similar to the intention module 308 and/or the message brokering module 359, in accordance with one or more implementations.

In some embodiments, an operation 411 may include generating one or more output text files based on the performed actions. Operation 411 may be performed by one or more hardware processors configured by machine-readable instructions including a module that is the same as or similar to the chat module 362, in accordance with one or more implementations.

In some embodiments, an operation 412 may include communicating the created one or more output text files to the markup module 365. Operation 412 may be performed by one or more hardware processors configured by machine-readable instructions including a module that is the same as or similar to the chat module 362, in accordance with one or more implementations.

In some embodiments, an operation 414 may include analyzing, by the sentiment analysis module 357 and/or the markup module 365, the received one or more output text files for sentiment and determining a sentiment parameter of the received one or more output text files. Operation 414 may be performed by one or more hardware processors configured by machine-readable instructions including a module that is the same as or similar to the sentiment analysis module 357, in accordance with one or more implementations.

In some embodiments, an operation 416 may include and based at least in part on the sentiment parameter determined by sentiment analysis, associating an emotion indicator, and/or multimodal output actions for the robot device with the one or more output text files. Operation 416 may be performed by one or more hardware processors configured by machine-readable instructions including a module that is the same as or similar to the markup module 365, in accordance with one or more implementations.

In some embodiments, an operation 420 may include verifying, by the prohibited speech filter, the one or more output text files do not include prohibited subjects or subject matters. Operation 420 may be performed by one or more hardware processors configured by machine-readable instructions including a module that is the same as or similar to an output filtering module 355, in accordance with one or more implementations. In some embodiments, prohibited speech may include violence-related topics and/or sexual related topics.

In some embodiments, an operation 422 may analyze the one or more output text files, the associated emotion indicator parameter or measurement, and/or multimodal output actions to verify conformance with robot device persona parameters and measurements. Operation 422 may be performed by one or more hardware processors configured by machine-readable instructions including a module that is the same as or similar to a persona protection module 356, in accordance with one or more implementations. In some embodiments, in operation 424, if the persona protection module 356 determines and/or identifies that the one or more output text files, the associated emotion indicator and the multimodal output actions are not in conformance with the robot's persona, the SocialX Chat module 362 or the SocialX intention module 308 may search for acceptable output text files, associated emotion indicators and/or multimodal output actions that match the robot device's persona parameters and/or measurements. In some embodiments, the SocialX Chat module 362 or SocialX module 308 may search the one or more memory modules 366 and/or the knowledge database 360 for the acceptable one or more output text files, the associated emotion indicator and the multimodal output actions. In some embodiments, in operation 426, if the acceptable one or more output text files, the associated emotion indicator and the multimodal output actions are located after the search process, the SocialX intention module 308 may communicate the one or more output text files, the emotion indicator and/or the multimodal output actions to the robot computing device. If some embodiments, in operation 428, if no acceptable one or more output text files, the associated emotion indicator and the multimodal output actions are located after the search, the SocialX chat module 362 or the SocialX module 308 may retrieve redirect text files from the knowledge database 362 and/or the one or more memory modules 366 and may communicate the one or more redirect text files to the markup module 365.

FIG. 4C illustrates retrieving factual information requested and providing the factual information according to some embodiments. In some embodiments, in operation 430, the one or more input text files may be analyzed to identify factual information that is being requested. Operation 430 may be performed by one or more hardware processors configured by machine-readable instructions including a module that is the same as or similar to a message brokering module 356, in accordance with one or more implementations. In some embodiments, in operation 432, a SocialX Question and Answer module 368, may communicate with a third-party interface 361 to obtain the requested factual information. In some embodiments, the third-party interface (e.g., an API) 361 may be a pathway or gateway to an external computing device running application software or separate application software having the requested factual information. In some embodiments, the application software and/or API may be an encyclopedia program (e.g., Merriam Webster program, a third-party software application, and/or StackOverflow for software development). Operation 432 may be performed by one or more hardware processors configured by machine-readable instructions including a module that is the same as or similar to SocialX Q&A module 368 and/or a third-party API 361, in accordance with one or more implementations, or an active website connected to the robot computing device such as the Global Robotics website.

In some embodiments, the factual information may be located from another source which may be located in the cloud-based computing device. In some embodiments, in operation 433, the factual information may be retrieved from the knowledge database 360 and/or the one or more memory modules 366. Operation 433 may be performed by one or more hardware processors configured by machine-readable instructions including a module that is the same as or similar to SocialX Q&A module 368 and/or the knowledge database 360, in accordance with one or more implementations. After gathering the factual information, in operation 434, the question/answer module 368 and/or the chat module 362 may add the retrieved or obtained factual information to the one or more output text files communicated to the markup module 365.

FIG. 4D illustrates a method of a SocialX cloud-based conversation module identifying special topics and redirecting conversation away from the special topic according to some embodiments. In some embodiments, the intention module 301 may include an input filter 351 to identify special topics and/or redirect the conversation away from these special topics. In some embodiments, in operation 440, the input filter module 351 may filter, via a special topics filter module, the one or more input text files to determine if the one or more input text files include special topics or defined special topics. In some embodiments, in operation 442, if the special topics filter module determines that the one or more input text files include special topics, the message brokering module may communicate with the chat module 362 to retrieve one or more specialized redirect text files to replace the input text files. In some embodiments, the special topics may include a topic that the user has indicated special interest in and or holiday topics (Christmas, Halloween, 4^{th} of July). In some embodiments, the one or more specialized redirect text files may provide instructions for the robot computing device to speak phrases such as “What presents would you like to give or receive at Christmas” or “Are you going with friends trick or treating” and/or if the user has shown an interest in the space shuttle, then “which space shuttle mission was your favorite” or “who is one of the space shuttle astronauts.” In some embodiments, in operation 444, the chat module 362 may communicate the one or more specialized redirect text files to the markup module 354 for processing.

FIG. 4E illustrates a cloud-based conversation module to utilize delay techniques in responding to users and/or consumers according to some embodiments. In some embodiments, the cloud-based conversation module 301 may have the ability to recognize when certain one or more input text files include conversations, subjects or topics that may take a while to respond to. In some embodiments, in operation 450, the intent manager module may analyze the one or more input text files to determine if the generation of output text files and/or associated files may be delayed to their complexity or subject matter (e.g., it may take a fair amount of time to process and/or understand the one or more input text files and the actions needed to respond to them). Examples of such complex topics or tasks include but are limited to: summarizing a prior conversation or conversations or pulling information from a third party source such as Wikipedia. In some embodiments, in operation 452, to mask and/or address this complexity, the intent manager module 308 and/or the chat module 362 may generate delay output text files, emotion parameters and/or delay multimodal output action files to mask a predicted delay in response time and keep the user engaged with the robot device.

FIG. 4F illustrates a cloud-based conversation module to extract and/or store contextual information from one or more input text files according to some embodiments. In some embodiments, after filtering has occurred and the one or more input text files have been communicated to the chat module 362, the chat module may also obtain contextual information from the user's speech so the chat module 362 can use this information later for use for conversations with the robot device. In other words, a context module of a chat module 352 may continuously collect information by keeping track of the conversation and the facts or subjects described therein. As an example, the user may state a place that they will visit and/or that they are planning to take a vacation next week. In some embodiments, in operation 460, a context module may analyze the received one or more input text files for contextual information from user's speech. In some embodiments, in operation 462, the chat Module may store the extracted contextual information in the one or more memory modules 366. In some embodiments, in operation 464, the chat module 362 may identify situations where the contextual information stored in the one or more memory modules 366 may be inserted into the one or more output text files after the actions have been performed on the one or more input text files (or other one or more input text files). In some embodiments, the contextual information may be inserted into the one or more output text files and communicated to the markup module 354. In some embodiments, the chat module may also allow for abstraction or simplification of the current conversation (and thus input text files) to reduce an amount of context to be processed and/or stored. For example, the context module may simplify “We went to Santa Monica from downtown over US Highway 10 to go to the beach” to the phrase “We went to the beach.” In some embodiments, in operation 466, the chat module 362 may analyze the one or more input text files for redundant information and may simplify the input text files to eliminate the detailed information and thus to reduce the amount of content (or size of the input text files that need to be stored in the one or more memory modules 366.

FIG. 4G illustrates analyzing for one or more input text files for relevant conversational and/or metaphorical aspects according to some embodiments. In some embodiments, a post-processing filter may also analyze other factors to determine the emotion indicator parameters and/or the multi-modal output action files that are to be communicated to the robot computing device. In some embodiments, in operation 470, the markup module may analyze the received one or more output text files for relevant conversational and/or metaphorical aspects. In some embodiments, in operation 472, the markup module may, based at least in part on the conversational and/or metaphorical analysis, associate and/or update an emotion indicator parameter and/or multimodal output action files for the robot computing device with the one or more output text files. Further, in some embodiments, in operation 474, the markup module may analyze the received one or more output text files for contextual information. In some embodiments, in operation 476, the markup module may, based at least in part on the contextual information analysis, associate an emotion indicator and/or multimodal output actions for the robot device with the one or more output text files.

In some embodiments, a method of establishing or generating multi-turn communications between a robot device and an individual, may include; accessing instructions from one or more physical memory devices for execution by one or more processors; executing instructions accessed from the one or more physical memory devices by the one or more processors; storing, in at least one of the physical memory devices, signal values resulting from having executed the instructions on the one or more processors; wherein the accessed instructions are to enhance conversation interaction between the robot device and the individual; and wherein executing the conversation interaction instructions further comprising: receiving, from a speech-to-text recognition computing device, one or more input text files associated with the individual's speech; filtering, via a prohibited speech filter, the one or more input text files to verify the one or more input text files are not associated with prohibited subjects; analyzing the one or more input text files to determine an intention on the individuals speech; and performing actions on the one or more input text files based at least in part on the analyzed intention. In some embodiments, the method may include generating one or more output text files based on the performed actions; communicating the created one or more output text files to the markup module; analyzing, by the markup module, the received one or more output text files for sentiment, based at least in part on the sentiment analysis, associating an emotion indicator, and/or multimodal output actions for the robot device with the one or more output text files; verifying, by the prohibited speech filter, the one or more output text files do not include prohibited subjects; analyzing the one or more output text files, the associated emotion indicator and the multimodal output actions to verify conformance with the robot device persona parameters; and communicating the one or more output text files, the associated emotion indicator and the multimodal output actions to the robot device.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method of establishing or generating multi-turn communications between a robot device and an individual, comprising:
accessing instructions from one or more physical memory devices for execution by one or more processors;
executing instructions accessed from the one or more physical memory devices by the one or more processors;
storing, in at least one of the physical memory devices, signal values resulting from having executed the instructions on the one or more processors;
wherein the accessed instructions are to enhance conversation interaction between the robot device and the individual; and
wherein executing the conversation interaction instructions further comprising:
receiving, from a speech-to-text recognition computing device, one or more input text files associated with the individual's speech;
filtering, via a prohibited speech filter, the one or more input text files to verify the one or more input text files are not associated with prohibited subjects;
analyzing the one or more input text files to determine an intention on the individuals speech;
performing actions on the one or more input text files based at least in part on the analyzed intention;
generating one or more output text files based on the performed actions;
communicating the created one or more output text files to the markup module;
analyzing, by the markup module, the received one or more output text files for sentiment,
based at least in part on the sentiment analysis, associating an emotion indicator, and/or multimodal output actions for the robot device with the one or more output text files:
verifying, by the prohibited speech filter, the one or more output text files do not include prohibited subjects;
analyzing the one or more output text files, the associated emotion indicator and the multimodal output actions to verify conformance with the robot device persona parameters; and
communicating the one or more output text files, the associated emotion indicator and the multimodal output actions to the robot device.

2. The method of claim 1, wherein executing the conversation interaction instructions further comprises:
before the one or more input text files are received, filtering, via a dialog manager module in the robot device, the one or more input text files to determine whether social chat modules of the cloud-based computing device should be utilized to process the one or more input text files.

3. The method of claim 2, wherein the dialog manager module in the robot device analyzes the one or more input text files to determine if a special command was received, an open question is present, or there is a lack of matching existing conversation patterns on the robot device in order to determine whether or not to communicate the one or more input text files to the social chat modules of the cloud-based computing device.

4. The method of claim 1, wherein executing the conversation interaction instructions further comprising:
wherein if the intent manager module determines that a delay may occur in receiving the one or more output text files, generating delay output text files and/or delay multimodal output action files to mask a delay in response time.

5. The method of claim 1, wherein executing the conversation interaction instructions further comprising: if the prohibited speech filter identifies that the one or more input text files are associated with the prohibited subjects, the prohibited speech filter communicating with the knowledge database and the knowledge database communicating one or more safe output text files to the chat module.

6. The method of claim 1, wherein executing the conversation interaction instructions further comprising:
filtering, via a special topics filter, the one or more input text files to determine if the one or more input text files include special topics;
retrieving one or more specialized redirect text files if the special topics filter determines the one or more input text files include the special topics; and
communicating the one or more specialized redirect text files to the markup module for processing.

7. The method of claim 1, wherein the special topics include Christmas, holiday or birthday topics.

8. The method of claim 1, wherein executing the conversation interaction instructions further comprising:
if the output persona filter determines the one or more output text files, the associated emotion indicator and the multimodal output actions do not conform with the robot device persona parameters,
searching, by the social chat module, for acceptable output text files, associated emotion indicators, and/or multimodal output actions in a knowledge database and/or the one or memory modules.

9. The method of claim 8, wherein executing the conversation interaction instructions further comprising:
If the social chat module locates one or more acceptable output text files, associated emotion indicators, and/or multimodal output actions,
the social chat module communicating the acceptable output text files, associated emotion indicators, and/or multimodal output actions to the robot device.

10. The method of claim 8, wherein executing the conversation interaction instructions further comprising:
if the social chat module does not locale one or more acceptable output text files, associated emotion indicators, and/or multimodal output actions,
the social chat module retrieving one or more redirect text files from the knowledge database and/or the one or more memory devices, and
communicating the one or more redirect text files to the markup module for processing.

11. The method of claim 1, wherein the one or more output text files from the social chat module are analyzed to determine if words included in the one or more input text files include a question requiring data on an external computing device outside the one or more memory devices; and
the social chat module communicating with a third-party application programming interface to the external computing device to retrieve answer data with respect to the question in the input text files; and
inserting the retrieved answer data in the one or more output text files.

12. The method of claim 1, wherein executing the conversation interaction instructions further comprising:
analyzing, by a context module, the one or more input text files to extract factual contextual text information from the user's speech; and
storing the factual extracted contextual information in the one or more memory modules.

13. The method of claim 12, wherein executing the conversation interaction instructions further comprising:
identifying situations where past conversation factual extracted contextual information from the one or more memory modules may be inserted into the generated one or more output text files after the actions have been performed on the one or more input text files.

14. The method of claim 12, wherein executing the conversation interaction instructions further comprising:
identifying situations where other factual extracted contextual information from the one or more memory modules may be inserted into the generated one or more output text files after the actions have been performed on the one or more input text files.

15. The method of claim 12, wherein executing the conversation interaction instructions further comprising:
eliminating redundant text from the extracted contextual text information to generate relevant contextual text information; and
storing the relevant contextual text information in the one or more memory modules.

16. The method of claim 1, wherein the actions performed on the one or more input text files include identifying factual information requested in the one or more input text files;
wherein the actions performed on the one or more input text files include communicating with a third-party application programming interface to obtain the requested factual information from an external computing device or software program; and
wherein the actions performed on the one or more input text files include adding the obtained factual information to the generated one or more output text files communicated to the markup module.

17. The method of claim 1, wherein the actions performed on the one or more input text files include identifying factual information requested in the one or more input text files;
wherein the actions performed on the one or more input text files include communicating with a knowledge database and/or the one or more memory modules to obtain the requested factual information; or
wherein the actions performed on the one or more input text files include adding the obtained factual information to the generated one or more output text files communicated to the markup module.

18. The method of claim 1, wherein executing the conversation interaction instructions further comprising:
analyzing, by the markup module, the received one or more output text files for relevant conversational and/or metaphorical aspects; and
based at least in part on the conversational and/or metaphorical analysis associating an emotion indicator and/or multimodal output actions for the robot device with the one or more output text files.

19. The method of claim 1, wherein executing the conversation interaction instructions further comprising:
analyzing, by the markup module, the received one or more output text files for contextual information; and
based at least in part on the contextual information analysis, associating an emotion indicator and/or multimodal output actions for the robot device with the one or more output text files.
